(19) United States
(12) Patent Application Publication
(10) Pub. No.: US 2014/0279434 A1
(43) Pub. Date: Sep. 18, 2014

(54) DEVICES, METHODS, AND SYSTEMS FOR MANAGING ONE OR MORE RESOURCES FOR ONE OR MORE EXTRINSIC CLIENT ENTITIES

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(21) Appl. No.: 14/026,963

(22) Filed: Sep. 13, 2013

Related U.S. Application Data
(63) Continuation-in-part of application No. 13/843,118, filed on Mar. 15, 2013.
Application No. 13/843,118 is a continuation-in-part of application No. 13/907,565, filed on May 31, 2013.
Application No. 13/907,565 is a continuation-in-part of application No. 13/907,627, filed on May 31, 2013.
Application No. 13/907,627 is a continuation-in-part of application No. 13/932,914, filed on Jul. 1, 2013.
Application No. 13/932,914 is a continuation-in-part of application No. 13/932,991, filed on Jul. 1, 2013.
Application No. 13/932,991 is a continuation-in-part of application No. 13/932,918, filed on Jul. 1, 2013.
Application No. 13/932,918 is a continuation-in-part of application No. 13/932,993, filed on Jul. 1, 2013.
Application No. 13/932,993 is a continuation-in-part of application No. 13/934,134, filed on Jul. 2, 2013.
Application No. 13/934,134 is a continuation-in-part of application No. 13/934,139, filed on Jul. 2, 2013.
Application No. 13/934,139 is a continuation-in-part of application No. 13/964,580, filed on Aug. 12, 2013.
Application No. 13/964,580 is a continuation-in-part of application No. 13/964,668, filed on Aug. 12, 2013.
Application No. 13/964,668 is a continuation-in-part of application No. 13/964,585, filed on Aug. 12, 2013.
Application No. 13/964,585 is a continuation-in-part of application No. 13/964,673, filed on Aug. 12, 2013.

(51) Int. Cl. G06Q 20/08

(52) U.S. Cl. CPC G06Q 20/08
USPC 705/39

(57) ABSTRACT

Systems, devices, and computationally implemented methods include acquiring a request for assistance in facilitation of a potential transaction between an extrinsic client configured to use an extrinsic client payment channel and a vendor configured to use a vendor payment channel that is at least partially different than the extrinsic client payment channel, identifying a resource to assist in facilitation of the transaction between the extrinsic client and the vendor, said identifying at least partially based on a characteristic of the resource, providing potential transaction data related to one or more of the extrinsic client and the vendor, to the identified resource, to assist in facilitation of the potential transaction, and providing resource data to one or more of the extrinsic client and the vendor, said resource data related to the identified one or more resource. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/843,118, entitled METHODS AND SYSTEMS FOR IMPLEMENTING VARIOUS TRANSACTIONAL ARCHITECTURES, naming Pablos Holman, Roderick A. Hyde, Royce A. Levien, Richard T. Lord, Robert W. Lord, and Mark A. Malamud as inventors, filed 15 Mar. 2013 with attorney docket no. 0213-003-001-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,565, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-002-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,627, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-045-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,914, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-003-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,991, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-046-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,918, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-004-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,993, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-047-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,134, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-005-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,139, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-048-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/964,580, entitled DEVICES, METHODS, AND SYSTEMS FOR ACCEPTING MULTIPLE NONUNIFORM INPUT CHANNELS, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-006-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/964,668, entitled DEVICES, METHODS, AND SYSTEMS FOR ACCEPTING MULTIPLE NONUNIFORM INPUT CHANNELS, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-049-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/964,585, entitled DEVICES, METHODS, AND SYSTEMS FOR ASSISTING MULTIPLE DISCRETE DEVICES, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-007-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/964,673, entitled DEVICES, METHODS, AND SYSTEMS FOR ASSISTING MULTIPLE DISCRETE DEVICES, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-050-000000, which is currently co-pending or is an application of which a currently co-pending application is entitled to the benefit of the filing date.

### RELATED APPLICATIONS

U.S. patent application Ser. No. 14/026,256, entitled DEVICES, METHODS, AND SYSTEMS FOR INTERACTIONS BETWEEN INTERMEDIARY DEVICES AND EXTRINSIC CLIENT DEVICES, naming Pablos Holman, Roderick A. Hyde, Royce A. Levien, Richard T. Lord, Robert W. Lord, and Mark A. Malamud as inventors, filed 13 Sep. 2013 with attorney docket no. 0213-003-008-000000, is related to the present application.

U.S. patent application Ser. No. 14/026,897, entitled DEVICES, METHODS, AND SYSTEMS FOR INTERACTIONS BETWEEN INTERMEDIARY DEVICES AND EXTRINSIC CLIENT DEVICES, naming Pablos Holman, Roderick A. Hyde, Royce A. Levien, Richard T. Lord, Robert W. Lord, and Mark A. Malamud as inventors, filed 13 Sep. 2013 with attorney docket no. 0213-003-051-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to data services.

### SUMMARY

In one or more various aspects, a method includes but is not limited to acquiring a request for assistance in a facilitation of a potential transaction between an extrinsic client configured to use an extrinsic client payment channel and a vendor configured to use a vendor payment channel that is at least partially different than the extrinsic client payment channel, identifying one or more resources configured to assist in the facilitation of the potential transaction between the extrinsic client and the vendor, said identifying at least partially based on a characteristic of the one or more resources, providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and providing resource data to one or more of the extrinsic client and the vendor, said resource data related to the identified one or more resources. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for acquiring a request for assistance in a facilitation of a potential transaction between an extrinsic client configured to use an extrinsic client payment channel and a vendor configured to use a vendor payment channel that is at least partially different than the extrinsic client payment channel, means for identifying one or more resources configured to assist in the facilitation of the potential transaction between the extrinsic client and the vendor, said identifying at least partially based on a characteristic of the one or more resources, means for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and means for providing resource data to one or more of the extrinsic client and the vendor, said resource data related to the identified one or more resources. In addition to the foregoing, other system aspects are described in the claims, drawings, and text forming a part of the disclosure set forth herein.

In one or more various aspects, a system includes, but is not limited to, circuitry for acquiring a request for assistance in a facilitation of a potential transaction between an extrinsic client configured to use an extrinsic client payment channel and a vendor configured to use a vendor payment channel that is at least partially different than the extrinsic client payment channel, circuitry for identifying one or more resources configured to assist in the facilitation of the potential transaction between the extrinsic client and the vendor, said identifying at least partially based on a characteristic of the one or more resources, circuitry for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and providing resource data to one or more of the extrinsic client and the vendor, said resource data related to the identified one or more resources. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for acquiring a request for assistance in a facilitation of a potential transaction between an extrinsic client configured to use an extrinsic client payment channel and a vendor configured to use a vendor payment channel that is at least partially different than the extrinsic client payment channel, one or more instructions for identifying one or more resources configured to assist in the facilitation of the potential transaction between the extrinsic client and the vendor, said identifying at least partially based on a characteristic of the one or more resources, one or more instructions for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and one or more instructions for providing resource data to one or more of the extrinsic client and the vendor, said resource data related to the identified one or more resources. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for acquiring a request for assistance in a facilitation of a potential transaction between an extrinsic client configured to use an extrinsic client payment channel and a vendor configured to use a vendor payment channel that is at least partially different than the extrinsic client payment channel, one or more interchained physical machines ordered for identifying one or more resources configured to assist in the facilitation of the potential transaction between the extrinsic client and the vendor, said identifying at least partially based on a characteristic of the one or more resources, one or more interchained physical machines ordered for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and one or more interchained physical machines ordered for providing resource data to one or more of the extrinsic client and the vendor, said resource data related to the identified one or more resources.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A-1AI, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A-1AI are stitched together in the manner shown in FIG. 1E, which is reproduced below in table format.

TABLE 1
Table showing alignment of enclosed drawings to form partial schematic of one
or more environments.

| | | | | |
|---|---|---|---|---|
| (1, 1) - FIG. 1A | (1, 2) - FIG. 1B | (1, 3) - FIG. 1C | (1, 4) - FIG. 1D | (1, 5) - FIG. 1E |
| (2, 1) - FIG. 1F | (2, 2) - FIG. 1G | (2, 3) - FIG. 1H | (2, 4) - FIG. 1I | (2, 5) - FIG. 1J |
| (3, 1) - FIG. 1K | (3, 2) - FIG. 1L | (3, 3) - FIG. 1M | (3, 4) - FIG. 1N | (3, 5) - FIG. 1O |
| (4, 1) - FIG. 1P | (4, 2) - FIG. 1Q | (4, 3) - FIG. 1R | (4, 4) - FIG. 1S | (4, 5) - FIG. 1T |
| (5, 1) - FIG. 1U | (5, 2) - FIG. 1V | (5, 3) - FIG. 1W | (5, 4) - FIG. 1X | (5, 5) - FIG. 1Y |
| (6, 1) - FIG. 1Z | (6, 2) - FIG. 1AA | (6, 3) - FIG. 1AB | (6, 4) - FIG. 1AC | (6, 5) - FIG. 1AD |
| (7, 1) - FIG. 1AE | (7, 2) - FIG. 1AF | (7, 3) - FIG. 1AG | (7, 4) - FIG. 1AH | (7, 5) - FIG. 1AI |

FIG. 1A, when placed at position (1,1), forms at least a portion of a partially schematic diagram of an environment(s) and/or an implementation(s) of technologies described herein.

FIG. 1B, when placed at position (1,2), forms at least a portion of a partially schematic diagram of an environment(s) and/or an implementation(s) of technologies described herein.

FIG. 1C, when placed at position (1,3), forms at least a portion of a partially schematic diagram of an environment(s) and/or an implementation(s) of technologies described herein.

FIG. 1D, when placed at position (1,4), forms at least a portion of a partially schematic diagram of an environment(s) and/or an implementation(s) of technologies described herein.

FIG. 1E, when placed at position (1,5), forms at least a portion of a partially schematic diagram of an environment(s) and/or an implementation(s) of technologies described herein.

FIG. 1F, when placed at position (2,1), forms at least a portion of a partially schematic diagram of an environment(s) and/or an implementation(s) of technologies described herein.

FIG. 1G, when placed at position (2,2), forms at least a portion of a partially schematic diagram of an environment(s) and/or an implementation(s) of technologies described herein.

FIG. 1H, when placed at position (2,3), forms at least a portion of a partially schematic diagram of an environment(s) and/or an implementation(s) of technologies described herein.

FIG. 1I, when placed at position (2,4), forms at least a portion of a partially schematic diagram of an environment(s) and/or an implementation(s) of technologies described herein.

FIG. 1J, when placed at position (2,5), forms at least a portion of a partially schematic diagram of an environment(s) and/or an implementation(s) of technologies described herein.

FIG. 1K, when placed at position (3,1), forms at least a portion of a partially schematic diagram of an environment(s) and/or an implementation(s) of technologies described herein.

FIG. 1L, when placed at position (3,2), forms at least a portion of a partially schematic diagram of an environment(s) and/or an implementation(s) of technologies described herein.

FIG. 1M, when placed at position (3,3), forms at least a portion of a partially schematic diagram of an environment(s) and/or an implementation(s) of technologies described herein.

FIG. 1N, when placed at position (3,4), forms at least a portion of a partially schematic diagram of an environment(s) and/or an implementation(s) of technologies described herein.

FIG. 1O, when placed at position (3,5), forms at least a portion of a partially schematic diagram of an environment(s) and/or an implementation(s) of technologies described herein.

FIG. 1P, when placed at position (4,1), forms at least a portion of a partially schematic diagram of an environment(s) and/or an implementation(s) of technologies described herein.

FIG. 1Q, when placed at position (4,2), forms at least a portion of a partially schematic diagram of an environment(s) and/or an implementation(s) of technologies described herein.

FIG. 1R, when placed at position (4,3), forms at least a portion of a partially schematic diagram of an environment(s) and/or an implementation(s) of technologies described herein.

FIG. 1S, when placed at position (4,4), forms at least a portion of a partially schematic diagram of an environment(s) and/or an implementation(s) of technologies described herein.

FIG. 1T, when placed at position (4,5), forms at least a portion of a partially schematic diagram of an environment(s) and/or an implementation(s) of technologies described herein.

FIG. 1U, when placed at position (5,1), forms at least a portion of a partially schematic diagram of an environment(s) and/or an implementation(s) of technologies described herein.

FIG. 1V, when placed at position (5,2), forms at least a portion of a partially schematic diagram of an environment(s) and/or an implementation(s) of technologies described herein.

FIG. 1W, when placed at position (5,3), forms at least a portion of a partially schematic diagram of an environment(s) and/or an implementation(s) of technologies described herein.

FIG. 1X, when placed at position (5,4), forms at least a portion of a partially schematic diagram of an environment(s) and/or an implementation(s) of technologies described herein.

FIG. 1Y, when placed at position (5,5), forms at least a portion of a partially schematic diagram of an environment(s) and/or an implementation(s) of technologies described herein.

FIG. 1Z, when placed at position (6,1), forms at least a portion of a partially schematic diagram of an environment(s) and/or an implementation(s) of technologies described herein.

FIG. 1AA, when placed at position (6,2), forms at least a portion of a partially schematic diagram of an environment(s) and/or an implementation(s) of technologies described herein.

FIG. 1AB, when placed at position (6,3), forms at least a portion of a partially schematic diagram of an environment(s) and/or an implementation(s) of technologies described herein.

FIG. 1AC, when placed at position (6,4), forms at least a portion of a partially schematic diagram of an environment(s) and/or an implementation(s) of technologies described herein.

FIG. 1AD, when placed at position (6,5), forms at least a portion of a partially schematic diagram of an environment(s) and/or an implementation(s) of technologies described herein.

FIG. 1AE, when placed at position (7,1), forms at least a portion of a partially schematic diagram of an environment(s) and/or an implementation(s) of technologies described herein.

FIG. 1AF, when placed at position (7,2), forms at least a portion of a partially schematic diagram of an environment(s) and/or an implementation(s) of technologies described herein.

FIG. 1AG, when placed at position (7,3), forms at least a portion of a partially schematic diagram of an environment(s) and/or an implementation(s) of technologies described herein.

FIG. 1AH, when placed at position (7,4), forms at least a portion of a partially schematic diagram of an environment(s) and/or an implementation(s) of technologies described herein.

FIG. 1AI, when placed at position (7,5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of an external coordination device 240 operating in an exemplary environment 200, according to one or more embodiments.

FIG. 3, including FIGS. 3A-3E, shows a particular perspective of a request for assistance in facilitation of a potential transaction between an extrinsic client configured to use an extrinsic client payment channel and a vendor configured to use a vendor payment channel that is at least partially different than the extrinsic client payment channel acquiring module 252 of processing module 250 of external coordination device 240 of FIG. 2B, according to an embodiment.

FIG. 4, including FIGS. 4A-4C, shows a particular perspective of a one or more resources configured to assist in facilitation of the transaction between the extrinsic client and the vendor identifying at least partially based on a characteristic of the one or more resources module 254 of processing module 250 of external coordination device 240 of FIG. 2B, according to an embodiment.

FIG. 5, including FIGS. 5A-5E, shows a particular perspective of a transaction data related to one or more of the extrinsic client and the vendor and configured to be used by the identified one or more resources providing to the identified one or more resources module 256 of processing module 250 of external coordination device 240 of FIG. 2B, according to an embodiment.

FIG. 6, including FIGS. 6A-6B, shows a particular perspective of an resource data related to the identified one or more resources providing to one or more of the extrinsic client and the vendor module 258 of processing module 250 of external coordination device 240 of FIG. 2B, according to an embodiment.

FIG. 7 is a high-level logic flowchart of a process, e.g., operational flow 700, according to an embodiment.

FIG. 8A is a high-level logic flow chart of a process depicting alternate implementations of an acquiring a request operation 702, according to one or more embodiments.

FIG. 8B is a high-level logic flow chart of a process depicting alternate implementations of an acquiring a request operation 702, according to one or more embodiments.

FIG. 8C is a high-level logic flow chart of a process depicting alternate implementations of an acquiring a request operation 702, according to one or more embodiments.

FIG. 8D is a high-level logic flow chart of a process depicting alternate implementations of an acquiring a request operation 702, according to one or more embodiments.

FIG. 8E is a high-level logic flow chart of a process depicting alternate implementations of an acquiring a request operation 702, according to one or more embodiments.

FIG. 8F is a high-level logic flow chart of a process depicting alternate implementations of an acquiring a request operation 702, according to one or more embodiments.

FIG. 9A is a high-level logic flow chart of a process depicting alternate implementations of an identifying one or more resources operation 704, according to one or more embodiments.

FIG. 9B is a high-level logic flow chart of a process depicting alternate implementations of an identifying one or more resources operation 704, according to one or more embodiments.

FIG. 9C is a high-level logic flow chart of a process depicting alternate implementations of an identifying one or more resources operation 704, according to one or more embodiments.

FIG. 9D is a high-level logic flow chart of a process depicting alternate implementations of an identifying one or more resources operation 704, according to one or more embodiments.

FIG. 10A is a high-level logic flow chart of a process depicting alternate implementations of a providing potential transaction data operation 706, according to one or more embodiments.

FIG. 10B is a high-level logic flow chart of a process depicting alternate implementations of a providing potential transaction data operation 706, according to one or more embodiments.

FIG. 10C is a high-level logic flow chart of a process depicting alternate implementations of a providing potential transaction data operation 706, according to one or more embodiments.

FIG. 10D is a high-level logic flow chart of a process depicting alternate implementations of a providing potential transaction data operation 706, according to one or more embodiments.

FIG. 10E is a high-level logic flow chart of a process depicting alternate implementations of a providing potential transaction data operation 706, according to one or more embodiments.

FIG. 11A is a high-level logic flow chart of a process depicting alternate implementations of a providing resource data operation 708, according to one or more embodiments.

FIG. 11B is a high-level logic flow chart of a process depicting alternate implementations of a providing resource data operation 708, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for acquiring a request for assistance in a facilitation of a potential transaction between an extrinsic client configured to use an extrinsic client payment channel and a vendor configured to use a vendor payment channel that is at least partially different than the extrinsic client payment channel, identifying one or more resources configured to assist in the facilitation of the potential transaction between the extrinsic client and the vendor, said identifying at least partially based on a characteristic of the one or more resources, providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, and providing resource data to one or more of the extrinsic client and the vendor, said resource data related to the identified one or more resources.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructionsper_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIG. 1, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, vendors offer payment channels for completing transactions. In known systems, users have payment channels that they want to use to carry out transactions. Sometimes, a user payment channel may be different than a vendor payment channel. For example, a user may not have her credit card present on her person, but may have her smartphone. The vendor may only accept credit card swipe with signature.

In an embodiment, the user device may manage payment channels for a user, so that when the vendor supplies a set of possible vendor payment channels, the user may select one or more of the payment channels based on one or more user preferences.

This application uses the words “user” and “client” interchangeably, to further underscore the intention that “user” may not necessarily be a person, but any entity that has a relationship with the vendor. The use of the word “client” does not impute any relationship between the entity and the vendor other than the potential for an exchange of goods and/or services for compensation between the client and the vendor.

Referring now to FIG. 1, FIG. 1 illustrates an exemplary system environment in which one or more methods, systems, circuitry, articles of manufacture, and computer program products and architecture, in accordance with various embodiments, may interoperate. FIG. 1 may show one or more systems that may operate in coordination or independently. One or more portions of systems in FIG. 1 may operate as a complete system, or as a component of a larger system.

Referring now to FIG. 1, FIG. 1 shows a payment initiation module 2210. The payment initiation module may be part of user device 120, or may be a separate device. Payment initiation module 2210 may be any module that detects a user's intention to carry out one or more transaction. The detection of a user's intention to carry out one or more transactions may be relayed from another device, may be inferred, directly or indirectly, from user input, may be inferred from user action (e.g., a user places an item in a shopping cart, or pours a cup of coffee, or takes a bottle of wine off of a shelf), may be initiated by a person that is observing the user or otherwise interacting with the user (e.g., a barista at a coffee shop, or a technician in a mobile device store). In an embodiment, this module may be designed to provide the user with a seamless interface, e.g., the displaying of a “pay now” button, which will be described in more detail herein with respect to the “context sensitive pay button branch” observable extending to the left of payment initiation module 2210 in the context of FIG. 1. It is noted that the direction here and in other places throughout FIG. 1 was chosen merely for illustrative purposes and has no bearing or effect on the operation of the various modules and/or components of FIG. 1.

Referring again to FIG. 1, in an embodiment, payment initiation module 2210 may include payment initiation exemplary module 2210A, which is illustrated as a module that is designed to carry out an exemplary, non-limiting example embodiment, specifically, that a user desires to pay for an item that the user has selected at a store. In an example, the user has selected a bottle of wine, for which the user desires to pay. In this example, the user is in a wine store, but in another example, the store could be virtual, and the user could be in their home or at another location browsing a virtual store on a computer, tablet, mobile phone, or other device.

In an embodiment, payment initiation module 2210 may include simple payment initiation module that may initiate a simplified payment branching module, in which a user wants to pay for an item, or determine how much an item costs, or determine whether there is enough money (e.g., cash or cash equivalents, e.g., points, rewards, rebates, coupons, tokens, etc.) in one or more accounts e.g., an item the user has taken a picture of, or placed in a cart, or grabbed, or poured, e.g., coffee in a coffee shop or soda out of a soda dispenser, and the action initiates payment, or a negotiation for payment, for the item or service. In an embodiment, a user may be wearing augmented reality glasses, and may look at an item and make some sort of hand, eye, or bodily gesture (e.g., waving the hand across the face), or speak a particular command or set of words, that indicates that the user desires to pay for an item. In an embodiment, the payment initiation may be a time based event, e.g., the start of a movie, if a user has gotten concessions from an usher or a popcorn stand, or the like, or the start of a round or an inning of a sporting event, e.g., a baseball game. In an embodiment, the details of the payment channel negotiation, either for modality, option, or both, may be hidden from the user as the completion of a transaction. In an embodiment, there may be a fixed system, e.g., a user may go to a video arcade, and receive twenty tokens worth of credits, and the simple payment initiation occurs each time the user performs an action that debits a token, until the tokens are expended.

In an embodiment, a user may be placed in an environment where the user is allowed to select multiple items, products, or services, up to a limit, which may be time, credit, money, or token-based, e.g., a buffet, or a payment for five minutes in an electronics store, or a payment that allows a user to select twenty different resistors from a bin at an electronics store, e.g., a Radio Shack. In such an embodiment, the payment initiation module may handle the negotiation of payment and alert the user when the limit has been reached.

In an embodiment, the details of how the payment is negotiated are hidden from the user. For example, the manner in which the vendor acquires payment, e.g., whether over a Wi-Fi network, or the equivalent scanning of a bar code, or the entry of a PIN number, may be obscured from the user, who may receive simplified information indicating the success or failure of the transaction, or, in an embodiment, less information than that.

In an embodiment, as shown in FIG. 1, payment branching may lead to one or more portions of a user device 120 (e.g., following the red arrow “south” or “downward”). User device 120 may include, among other elements, a device memory 126. Device memory 126 may store one or more of a user payment option set and a user payment modality set.

In an embodiment, “payment” may refer to any portion of a transaction between a user and a vendor, including the selection and/or identification of an item and/or a service. As a tangible example, the scanning of a barcode on a can of peaches at a grocery store may be part of the “payment.” As another example, a barista keying in a description of a coffee order from a user into a computing device may also be part of a “payment.” Payment may also include authentication of a user to determine a user is the entity that the user is claiming to be. Payment is used merely as a convenient shorthand to refer to the entire process from start to finish of the acquisition of one or more goods and/or services by a user, and is not intended to be limited to the point of the transaction in which money and/or money equivalents change possession from the user to the vendor.

Under the terminology of this application, “payment modality” may refer to the mechanic by which payment information is exchanged between the vendor and the user. “Payment option” refers to the type of payment utilized by the user, and may refer to a type of credit card, a type of debit card, a type of electronic currency, and the like. The term “payment channel” may refer to one or both of “payment modality” and “payment option.”

Referring again to FIG. 1, FIG. 1 shows exemplary payment options 2120. Exemplary payment options 2120 are not intended to be an exhaustive list, but merely exemplary of some of the various types of payment options. For example, exemplary payment options 2120 may include one or more of credit card A 2122 (e.g., which may be a credit card that includes travel rewards, e.g., discounts on travel expenses), credit card B 2124 (e.g., which may be a card that accumulates fuel purchasing rewards, e.g., discounts on gasoline expenses), personal debit card 2126, corporate credit card 2128, PayPal account 2132, frequent shopper rewards card 2134, gift certificate 2136 and 2137 (e.g., which could refer to a specific gift certificate, e.g., “ten dollar Starbucks card” that can be redeemed only at a particular vendor, or a generic gift certificate, e.g., an “American Express gift card,” that is valid and redeemable regardless of the vendor, or a combination of the two (e.g., a gift card good at any hardware store, or any store in the downtown area of a city), instant credit approval 2138, cash 2142, foreign currency 2144, and cash equivalents 2146.

Referring again to FIG. 1, FIG. 1 shows exemplary payment modalities 2320. Exemplary payment modalities 2320 are not intended to be an exhaustive list, but merely exemplary of some of the various types of payment modalities. For example, exemplary payment modalities 2320 may include one or more of virtual currency (e.g., BitCoins, or Xbox points, and the like), one-dimensional (1-D) barcode scan 2358, credit card with swipe only 2322, credit card with swipe and personal identification number (PIN) entry 2324, biometric retinal scan 2339, biometric fingerprint scan 2342, two-dimensional (2-D) barcode scan 2356, color barcode scan 2362, credit card with swipe and signature 2325, device tap, e.g., near field communication technology 2332, audio speech recognition (e.g., identifying the words that are spoken) 2344, audio voice recognition (e.g., identifying the speaker that has spoken, e.g., voiceprint analysis, or other voice identification techniques, PIN and/or password only 2352, trusted device voucher 2354, device authentication over a wireless network 2334, device authentication over a cellular network 2336, credit card proximity (e.g., via Radio-Frequency Identification (RFID)) 2326, credit card microchip 2364, electronic funds transfer 2368, device proxy 2348 (e.g., where another, more complex device performs one or more steps in completing the payment process), and three-dimensional object identification 2372.

As shown in FIG. 1, exemplary payment options 2120 and exemplary payment modalities 2320 are illustrated as “clouds” in the drawings. This is to indicate that the payment options and the payment modalities can be substituted anywhere in the system without substantially changing the system. Specific examples may be given with specific payment options and payment modalities, but substitution with other options and/or modalities, whether listed as exemplary in this application or not listed, will not substantially change the operation of this architecture and should be considered as within the scope of this invention.

Referring again to FIG. 1, user device 120 may include user payment channel obtaining module 2240. User payment channel obtaining module 2240 may obtain the various user payment channels through one or more techniques, whether retrieving from device memory, scanning the device, polling different portions of the device, receiving and/or retrieving data from a remote location, or a combination of these. Payment channel obtaining module 2240 also may be dynamic, e.g., may determine that Wi-Fi is not available as a payment modality if there is no available open wireless network. Similarly, a user may disable various modalities, e.g., a user may want to stop using Credit Card A at a particular time, for example, if the user is approaching a credit limit. Payment channel obtaining module 2240 may include one or more of user payment option set obtaining module 2220 and user payment modality set obtaining module 2230. User payment option set obtaining module 2220 may be configured to obtain the payment option set for that user under a particular set of conditions, or generally. Similarly, user payment modality set obtaining module 2230 may be configured to obtain the payment modality set for that user under a particular set of conditions, or generally.

In an embodiment, user payment option set obtaining module 2220 may include user payment option set receiving module 2222. User payment option set receiving module 2222 may receive a user payment option set from a location. In an embodiment, the user payment option set, e.g., an exemplary user payment option set 3010A, may be received from cloud storage, e.g., network storage, e.g., user payment channel set cloud storage module 3010. User payment channel set cloud storage module 3010 may be any form of storage that is remote to user device 120, regardless of the owner of the network space, or the characteristics of the space, e.g., shared, dedicated, specific, and the like.

In an embodiment, user payment option set receiving module 2222 may receive a user payment option set, e.g., exemplary user payment option set 3020B, from a user payment channel set home/enterprise server storage module 3020. Module 3020 may be a home server, for example, or may be a related device to a device carried by a user. For example, user device 120 may be a watch, or a pair of glasses, that provides functionality to a user, whereas a payment option set is stored on a phone device carried by the user, or on a phone device carried by a related user, e.g., a user's mother, classroom teacher, boss, and the like.

In an embodiment, user payment channel obtaining module 2240 may include one or more of user payment option set receiving module 2222, user payment option set retrieving module 2224, and user payment option set generating module 2226. In an embodiment, user payment modality set obtaining module 2230 may include user payment modality set receiving module 2232, user payment modality set retrieving module 2234, and user payment modality set 2236. In an embodiment, one or more of these modules may work together to obtain one or more of the user payment option set and the user payment modality set. It is noted here that “set” may include a set of one payment option, or a set of one payment modality, or an empty set (e.g., there are no available payment options under the current conditions). It is further noted that “set” implies any structure, e.g., data structure, capable of representing, storing, manipulating, transmitting, conveying, displaying, or otherwise acting upon or for data.

In an embodiment, the user payment channel obtaining module 2240 obtains the user payment channel. Referring again to FIG. 1, as an example, the obtained user payment channel set, e.g., obtained user payment channel 2260, may include user payment option set 2262 and user payment modality set 2264. It is noted that these are merely exemplary user payment option sets and user payment modality sets, and other embodiments may include other sets of various size and content. Also, although the user payment option set 2262 and the user payment modality set 2264 are illustrated separately, this is merely for ease of understanding and illustration. In an embodiment, there may be a single set that includes part or all of a user payment option set and a user payment modality set, or multiple sets that contain one or more portions of one or more of the user payment option set and the user payment modality set.

In an embodiment, the obtained user payment channel set 2260 may include user payment option set 2262. As an example, and merely for the purposes of illustration, user payment option set 2262 may include credit card A 2122 and personal debit card 2126. In an embodiment, the obtained user payment channel set 2260 may include user payment modality set 2264. As an example, and merely for the purposes of illustration, user payment modality set 2264 may include device tap near-field communication 2332 and audio-voice 2346.

In an embodiment, user device 120 also may include vendor payment channel obtaining module 2410. Although pictured as part of user device 120, this is merely for illustrative purposes. In another embodiment, user device 120 may be external to user device 120, or may communicate over any form of network or any other form of communication. Moreover, vendor payment channel obtaining module 2410 may be interpreted in the illustration as operating after user payment channel obtaining module 2240. In an embodiment, vendor payment channel obtaining module 2410 may operate after user payment channel obtaining module 2240. In other embodiments, vendor payment channel obtaining module 2410 may operate concurrently or before, or on a different thread, processor, device, or system, as user payment channel obtaining module 2240.

In an embodiment, vendor payment channel obtaining module 2410 may include a vendor interface module 2412. Vendor interface module 2412 may be configured to receive a transmission of one or more vendor payment options and/or one or more vendor payment modalities. For example, in an embodiment, vendor interface module 2412 receives a broadcast from vendor device 6100, e.g., vendor payment channel set broadcasting module 2612. In an embodiment, vendor interface module 2412 may include vendor payment option set 2462 and vendor payment modality set 2464.

In an embodiment, vendor payment channel obtaining module 2410 may include vendor interface retrieving module 2414. Vendor interface retrieving module 2414 may retrieve one or more portions of one or more of the vendor payment option set, e.g., vendor payment option set 2462, and vendor payment modality set 2464. In an embodiment, vendor interface retrieving module 2414 may include vendor interface retrieving from vendor module 2416 and vendor interface retrieving from trusted device module 2418. In an embodiment, vendor payment channel obtaining module 2410 may include one or more of vendor payment channel determining module 2422 and vendor payment channel detecting module 2422.

In an embodiment, vendor payment channel obtaining module 2410 may include vendor scanning module 2430. In an embodiment, vendor scanning module 2430 may be configured to use one or more tools, e.g., hardware, software, or a combination thereof, to scan the surroundings of the user device 120, or to scan related networks for information about the surroundings of user device 120, in order to obtain information about one or more vendor payment channel sets. For example, vendor scanning module may acquire information through various forms, as indicated in module 2430A. For example, the user device may acquire data about vendor payment channels from one or more trusted devices, one or more devices in the proximity that are sharing or willing to share data, through Internet network resources (e.g., social networks, e.g., Twitter, Facebook, and the like), through one or more specific databases that may be proprietary and may be provided by one or more manufacturers of devices and/or device operating systems, e.g., Apple, Inc.

In an embodiment, module 2430 may include one or more databases which may be read by vendor scanning module 2430. With respect to module 2430, the “database” may be replaced with any data structure, or may represent data that is scattered across one or more networks and collected by one or more services, which may or may not be acting under the direction of user device 120. For example, module 2430 may include vendor information proprietary database 2431A, vendor information from search engine/data repository 2431B, vendor information from polling/querying area devices 2431C, vendor information from polling/querying trusted devices 2431D, and vendor information from publicly available data 2431E. In an embodiment, one or more of these or other sources may be used to obtain a vendor payment option set and/or a vendor payment modality set.

In an embodiment, vendor payment channel obtaining module 2410 may obtain one or more vendor payment channel sets 2460. In an embodiment, and for exemplary and/or illustrative purposes only, vendor payment channel set 2460 may include vendor payment option set 2462 and/or vendor payment modality set 2464. In an embodiment, and only for exemplary purposes, vendor payment option set 2462 may include credit card A 2122 and cash 2142. In an embodiment, and only for exemplary purposes, vendor payment modality set 2464 may include credit card swipe+PIN 2324 and credit card swipe+signature 2325. In an embodiment, this information may be gathered by vendor scanning module 2430, which, in an embodiment, may query the vendor's network to determine which modalities of payment are recognized. In an embodiment, the vendor scanning module 2430 may use false data to sample the systems of the vendor, to determine what capabilities for modalities and payment options are possessed by the vendor.

In an embodiment, when the user payment channel sets (e.g., user payment channel set 2260) and the vendor payment channel sets (e.g., vendor payment channel set 2460) have been obtained, then, in an embodiment, payment option comparator module 2500 and payment modality comparator module 2700 may compare the vendor payment option set and the vendor payment modality set, respectively. In the illustrated embodiment, payment option comparator module 2500 and payment modality comparator module 2700 are shown as separate modules, however, in other embodiments, they may be the same module, or scattered across various devices, or integrated into device 120. In an embodiment, a programmable chip, e.g., a central processing unit, or a portion thereof, may act as both payment modality comparator module 2700 at time A and payment option comparator module 2500 at time B. In an embodiment, payment option comparator module 2500 and payment modality comparator module 2700 may be a part of user device 120.

Referring again to FIG. 1, payment option comparator module 2500 may receive the vendor payment option set 2504 and the user payment option set 2506. In an embodiment, payment option comparator module 2508 may compare all or a portion of vendor payment option set 2504 and the user payment option set 2506. It is noted that the sets may be traversed in any known manner or form for comparison, and it is not required that the entire set of either the vendor payment option set 2504 or the user payment option set 2506 be traversed in their entirety. In an embodiment, payment option comparator module 2508 may receive user preference input 2520 and/or vendor preference input 2522, which may suggest an order in which the payment option or options are to be ranked, categorized, selected, or otherwise preferred, relative to one another or generally. Input from these modules is optional and may vary from system to system.

In an embodiment, payment option comparator module 2508 may determine that there is an overlap between vendor payment option set 2504 and user payment option set 2506. In an embodiment, overlapping set detection module 2510 may generate a calculated overlapping set 2535. It is noted that overlapping set 2535 is not required to be the entire overlapping set 2535. For example, in an embodiment, payment option comparator module 2508 may stop as soon as payment option comparator module 2508 finds one match, and that single match becomes the calculated overlapping set 2535, regardless of whether there are additional overlapping sets.

In an embodiment, payment option comparator module 2508 may determine that there is no overlap between vendor payment option set 2504 and user payment option set 2506. In an embodiment, no overlap in set detection module 2512 may transfer control to no-overlap interfacing module 2530. In an embodiment, if no overlap is detected between the vendor payment option set 2504 and the user payment option set 2506, then the no-overlap interfacing module 2530 may branch to a payment option interfacing module 2550.

For example, for exemplary purposes, in the illustrated example, “Credit Card A” 2122 is found both in the vendor payment option set 2504 and the user payment option set 2506. Thus, in an embodiment, overlapping set detection module 2510 may be invoked, and calculated overlapping set 2535 may include the set of “Credit Card A” 2122. In another embodiment, however, if there is no overlap, then payment option interfacing module 2550 may be invoked.

In an embodiment, payment option interfacing module 2550 may be part of user device 120. In an embodiment, payment option interfacing module 2550 may partially be a part of user device 120, and partially exterior or external to user device 120. In an embodiment, payment option interfacing module 2550 may include payment option supplier contact module 2552. In an embodiment, payment option supplier contact module 2552 may contact one or more payment option administrators to determine if the user's payment option set 2506 can be expanded to include a payment option that is part of the vendor's payment option set 2504. For example, in an embodiment, payment option supplier contact module 2552 may contact the administrator of one or more of the vendor's payment options, to see if the administrator of the payment option (e.g., the credit card company, e.g., Visa) may grant the user access to their payment system, either temporarily, as in a one-use credit card, or permanently, e.g., the granting of a persistent credit line to the user. In an embodiment, payment option supplier contact module 2552 may contact an electronic payment supplier, e.g., PayPal, or Amazon Payments, and request a one-use username and password that the user can use to interact with the vendor system, and then the electronic payment supplier can interface with one of the user payment options to receive reimbursement for processing the transaction with the vendor's payment option.

In an embodiment, payment option interfacing module 2550 may include manufacturer store as intermediary payment option module 2554. For example, in an embodiment, the manufacturer store as intermediary payment option module 2554 may contact an administrator of an online store, e.g., the Apple store, and determine if the Apple store will act as an intermediary to charge the device using its payment systems that are in place, and then handling the payment to the vendor.

In an embodiment, payment option interfacing module 2550 may include related device as intermediary payment option module 2556. For example, in an embodiment, related device as intermediary payment option module 2556 may find a related device that will pay for the item for the user. A related device may be a device that is in the user devices' contact list, or a device that is close to the user, or a device that is on a predetermined list that was approved by the device user, or a device that shares one or more characteristics with the user, or a device for which the same entity is responsible for paying the operating costs. For example, in an embodiment, if the user device 120 that is involved in the transaction is operated by a minor, then the minor's parent's device may be a related device, and may have additional payment options that can be used to interface with the vendor, on behalf of the minor.

In an embodiment, related device as intermediary payment option 2556 may include one or more of a contact list device search module 2558, a proximity device search module 2560, a predetermined device search module 2561, and/or a same-contract device search module 2562. One or more of these modules may be used to find a related device through one or more various methods, or through other methods not detailed here (e.g., through a social network accessed by the user device).

In an embodiment, payment option interfacing module 2550 may include unrelated device as intermediary payment option module 2564, which, in an embodiment, may include contracting device search module 2566 that is configured to search for devices that will take on a contract to assist the user device. For example, a person unrelated to the user may authorize their device to act as a payment intermediary. This intermediary could be nonspecific, could be specific to a store (e.g., only assist for Kohl's), could be specific to a type of stores (e.g., only assist for grocery stores), could be context-dependent (e.g., only assist for a store in which the device owner is currently located), or only authorize their device to act as payment intermediary for certain user payment option types (e.g., only assist for cash transactions). The user of the unrelated device, and the unrelated device, would then bear all or a part of the burden for negotiating reimbursement from the user device, plus whatever fee is allowed or negotiated, either by the unrelated device, by the vendor, by a third party, or by a governmental entity.

In an embodiment, payment option interfacing module 2550 may include selected payment option interface transmitting module 2568, which may be configured to transmit the selected payment option, and/or one or more details about the logistics of the payment option, to the device 120. It is noted that this transmission may be virtual or internal to the device 120, and may not include an actual “transmission,” but merely a handling of data.

In an embodiment, payment option comparator module 2500 may result in a selected payment option 2480, which, in an embodiment, and solely for exemplary purposes, may be credit card A 2122.

In an embodiment, payment modality comparator module 2700 may result in a selected payment modality 2490. Referring again to FIG. 1, in an embodiment, payment modality comparator module 2700 may include modality comparator exemplary module 2702, which may be configured to determine whether there is any overlap between the user payment modality set and the vendor payment modality set. In an example, e.g., the example shown in FIG. 1, exemplary vendor payment modality set 2704 may include credit card swipe+PIN 2324 and credit card swipe+signature 2326.

In an embodiment, payment modality comparator module 2700 may include payment option comparator module 2708. Referring again to FIG. 1, payment modality comparator module 2700 may receive the vendor payment modality set 2704 and the user payment modality set 2706. In an embodiment, payment modality comparator module 2708 may compare all or a portion of vendor payment modality set 2704 and the user payment modality set 2706. It is noted that the sets may be traversed in any known manner or form for comparison, and it is not required that the entire set of either the vendor payment modality set 2704 or the user payment modality set 2706 be traversed in their entirety. In an embodiment, payment modality comparator module 2708 may receive user preference input 2720 and/or vendor preference input 2722, which may suggest an order in which the payment modality or modalities are to be ranked, categorized, selected, or otherwise preferred, relative to one another or generally. Input from these modules is optional and may vary from system to system.

In an embodiment, payment modality comparator module 2708 may determine that there is an overlap between vendor payment modality set 2704 and user payment modality set 2706. In an embodiment, overlapping set detection module 2710 may generate a calculated overlapping set 2735. It is noted that overlapping set 2735 is not required to be the entire overlapping set 2735. For example, in an embodiment, payment modality comparator module 2708 may stop as soon as payment modality comparator module finds one match, and that single match becomes the calculated overlapping set 2735, regardless of whether there are additional overlapping sets.

In an embodiment, payment modality comparator module 2708 may determine that there is no overlap between vendor payment modality set 2704 and user payment modality set 2706. In an embodiment, no overlap in set detection module 2712 may transfer control to no-overlap interfacing module 2730. In an embodiment, if no overlap is detected between the vendor payment modality set 2704 and the user payment modality set 2706, then the no-overlap interfacing module 2730 may branch to a payment modality interfacing module 2640.

In an embodiment, e.g., in an illustrated example as shown in FIG. 1, there may be no overlap between exemplary vendor payment modality set 2704 and exemplary user payment modality set 2706. Thus, in an embodiment, no-overlap interfacing module 2730 may interface with payment modality interfacing module 2640, which may be part of device 120, separate from device 120, or a portion of which may be a part of device 120.

In an embodiment, payment modality interfacing module 2640 may include payment modality user-device as broker module 2650. In an embodiment, payment modality user-device as broker module 2650 facilitates the interface between a user payment modality and a vendor payment modality. For example, payment modality user-device as broker module 2650 may include vendor-accepted modality selecting module 2654 that is configured to select a modality that is acceptable to the vendor and that the device can broker. For example, the vendor may require a credit card swipe and PIN number as a modality. The user may have “audio-voice” as a modality because he or she does not want to physically swipe their card at a station. Thus, the device may act as a broker between the two modalities. Vendor-accepted modality selecting module 2654 may determine that, because it has a microphone to record and convert the PIN, and access to a credit card database, the device can act as a broker between the two modalities.

For example, payment modality user-device as broker module 2650 may include modality adaptation module 2654, which may be configured to take one or more steps in facilitating “conversion” of one modality supported by the device into another. This may be transparent to the user, or may require user assistance. In an embodiment, e.g., the illustrated embodiment, in step 2654EX1, the device may request the user to use the audio-voice modality to speak a PIN number into the microphone of the device, which is recorded. In an embodiment, in step 2654EX2, the device may convert the inputted audio into a PIN number in the format accepted by the vendor. In an embodiment, in step 2654EX3, the credit card data corresponding to a magnetic strip swipe data may be retrieved from a credit card database, e.g., a database run by the credit card company.

In an embodiment, payment modality user-device as broker module 2650 may include converted modality interfacing module 2656, which acts to transmit the converted swipe data and the PIN to the vendor, which treats the transaction as if the user had swiped his or her card and entered his or her PIN data.

In an embodiment, payment modality interfacing module 2640 may include payment modality related-device as broker module 2660. In an embodiment, payment modality related-device as broker module 2660 may include vendor-accepted modality selecting module 2654, which selects one or more of the vendor modalities (for which there is no overlap) that the device is capable of brokering with assistance from another device. In an embodiment, payment modality related-device as broker module 2660 also may include criterion-meeting related device acquiring module 2662, which may use one or more search techniques to find a related device that can assist the user device in completing the transaction. The search for a related device may be similar to that described above.

In an embodiment, criterion-meeting related device acquiring module 2662 may include one or more of contact list device search module 2662A, proximity device search module 2662B, predetermined device search module 2662C, and same-contract device search module 2662D.

In an embodiment, payment modality related-device as broker module 2660 may include related device instructing module 2664, which may be configured to instruct the related device found by module 2662 regarding how to interface the vendor modality with the user device. In an embodiment, this may include transmitting payment information to the related device so that the related device may engage the vendor modality.

In an embodiment, payment modality interfacing module 2640 may include payment modality vendor equipment as broker module 2670. In an embodiment, a vendor may provide equipment, which may be third-party produced, that allows additional modalities. For example, an internet currency provider (e.g., BitCoin) may outfit various Starbucks with devices that allow BitCoin transactions to be processed, using the device as an intermediary, without changing the Starbucks infrastructure. A user device may find these broker devices (which may not be implemented entirely in hardware) and use them to facilitate transactions, and may be invisible to the end user.

In an embodiment, payment modality vendor equipment as broker module 2670 may include vendor equipment communication module 2672. In an embodiment, payment modality vendor equipment as broker module 2670 may include vendor equipment interfacing module 2674. In an embodiment, payment modality vendor equipment as broker module 2670 may include data transmission to vendor equipment module 2676. In an embodiment, payment modality vendor equipment as broker module 2670 may include transaction monitoring module 2678.

In an embodiment, payment modality interfacing module 2640 may include payment modality unrelated device as broker module 2680. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner), similarly to the unrelated device as intermediary payment option module 2564.

In an embodiment, payment modality interfacing module 2640 may include selected payment modality interface transmitting module 2568, which may transmit the selected payment modality, which in an embodiment, the transmission may be internal to the device or within the workings of a particular application or module.

In an embodiment, the selected payment modality 2490 may be paired with the selected payment option into a selected payment option and modality 2750. The combination may not be literal, it may be as simple as setting a flag indicating that a payment option and a payment modality have been selected. In an embodiment, the combination is omitted entirely, and shown in the illustration simply for ease of understanding the illustrated system.

In an embodiment, payment executing module 4000 may be a portion of the user device 120, or separate from the user device 120. Payment executing module 4000 may include vendor contacting module 4010 configured to contact the vendor to apply the payment. In an embodiment, payment executing module 4000 may include intermediary utilization applying module 4020, which may be configured to use any intermediaries, e.g., other devices, e.g., vendor devices, other user devices, other user's devices that are either related or unrelated to the user device, and the like, to assist in the carrying out of the payment.

In an embodiment, payment executing module 4000 may include intermediate steps module 4030, which may be used, for example, to convert one modality to the other, payment transmission module 4040 which may be used to transmit the payment using the selected modality, and confirmation receipt module 4050 which may communicate with the vendor to receive confirmation that the payment has been accepted.

Referring again to FIG. 1, in an embodiment, the payment initiation module 2210 may include a persistent payment button on the device module 2210C. In an embodiment, persistent payment button 2210C may represent a button that allows the user to pay, that does not change based on changing payment channels. It does not necessarily mean that the button is always present, although that may be the case in an embodiment. Persistent payment button 2210C may be a soft key or a hard key and may have a distinctive design or shape, and may be designed to be easy to access, in an embodiment. In an embodiment, persistent payment button 2210C may be a persistent payment soft button 7510. In an embodiment, the persistent payment soft button 7510 may be built into the device firmware. In another embodiment, the persistent payment soft button 7510 may be built into the operating system, or into another component or module of the device. In an embodiment, persistent payment button 2210C may be a physical, e.g., a hard button that is built into the device. For example, persistent payment button 2210C may be implemented as a persistent payment hard button 7512 that is built into the device. In another embodiment, persistent payment hard button 7512 may be programmed to operate as a persistent payment button under particular conditions, e.g., when a particular module is active, or when a particular condition is met. In an embodiment, for example, one or more devices with a persistent payment hard button 7512A may be provided when a user enters a retail store. For example, a wholesale superstore, e.g., a Wal-Mart, may hand out user devices having a persistent payment hard button 7512A to users as they enter the store, in order to facilitate one or more transactions.

In an embodiment, a module 2250 displays a single pay button on the user device. In an embodiment, module 2250 may include condition checking module 7522. Condition checking module 7522 may check one or more conditions to determine, e.g., when a particular module is active, or whether a particular condition is met. In an embodiment, module 2250 may include vendor communication maintaining module 7524. Vendor communication maintaining module 7524 may include a communication module for communicating with the vendor through one or more networks or other media. For example, a user device may communicate with the vendor through a closed vendor network, or through a wireless network provided by the vendor, or through a 4G LTE network provided by an unrelated communication network provider. In an embodiment, module 2250 may include payment channel monitoring module 7526. Module 7526 may monitor one or more payment channels of the user, the user device, or the vendor, and update if one or more of the monitored payment channels changes or becomes active or inactive.

In an embodiment, an input receiving module 7530 may receive input from the persistent payment button 2210C. For example, module 7530 may include button pushing receiving module 7533, which may detect when the persistent payment button 2210C is pressed. In another embodiment, however, persistent payment button 2210C may not be a button, but some other sort of non-button trigger, e.g., a gesture made while operating an augmented reality device, or an infrared signal. In an embodiment, non-button interface receiving module 7532 of input receiving module 7530 may receive the input indicating a potential transaction from the non-button implementation of the persistent payment button.

Then, in an embodiment, using methods previously described, a vendor payment channel acquiring module 2252 acquires an indication that the persistent payment button has been activated, and acquires, e.g., detects, receives, retrieves, or otherwise obtains, the vendor payment channel, e.g., using the vendor payment channel detecting module 2254, partly to detect the vendor payment channels. In an embodiment, vendor payment channel detecting module 2254 may access one or more external resources 2280, as previously described. Specifically, in an embodiment, the selected payment modality and option may be applied to execute the user's request to initiate payment, using the persistent payment button 2210C, and transparently, or partially transparently to the user, with the context of the device (e.g., location, and other factors) determining what specifically the persistent payment button 2210C carries out. In an embodiment, vendor payment channel acquiring module 2252 may include vendor transmission of payment options and/or payment modalities receiving module 7528, which may receive one or more payment options and/or one or more payment modalities from the vendor.

In an embodiment, multi-purpose device 7500 may also include an automated user payment channel selection module 7540, which, in an embodiment, may select a user payment channel for use in carrying out at least a portion of the transaction. In an embodiment, the selection may occur without user intervention. In another embodiment, the selection may include user intervention. Module 7540 may include one or more of payment channel comparator module 7542, weighted payment channel selecting module 7544, and payment channel selecting with non-user external automated input module 7546, which may select a user payment channel automatically, e.g., without further user input after the transaction has been initiated. In an embodiment, e.g., with the use of input module 7546, the process of selecting a user payment channel may be influenced or directly controlled by an external resource, which may or may not be related to the user or the user device.

In an embodiment, multi-purpose device 7500 may include selected automated user payment channel adaptation to one or more vendor payment channel modules 7550. For example, in an embodiment, module 7550 may include external resource for payment channel adapting module 2258, which may be configured to use one or more external resources to complete payment using a context-dependent vendor channel, e.g., through one or more external resources 2280.

In an embodiment, multi-purpose device 7500 may include potential transaction facilitating module 7560, which may include one or more communication modules for communicating with the vendor for which the potential transaction is being negotiated. In an embodiment, potential transaction facilitating module 7540 may include vendor payment systems communication module 7562.

In an embodiment, multi-purpose device 7500 may be implemented with one or more options or modifications. For example, in an embodiment, multi-purpose device 7500 may be implemented as described in payment option hard cap limiter 7520A. In that example, a user has more goods in his or her shopping cart than what he or she has funds to pay with using one or more user payment options of the user payment channel set. Using payment option hard cap limiter 7520A, a user may take items out of his or her shopping cart (which may exist in any known implementation, whether virtual or real), until a signal, e.g., the payment button changes or lights up, or some other appropriate signal, indicating that there are enough funds in the account to pay for the items.

In an embodiment, multi-purpose device 7500 may be implemented as payment option soft cap limiter example 7520B. For example, in an embodiment, a user may add things to his or her shopping car (which may be virtual or physical) until the button goes out, indicating he has overstepped how much funds are in the account, or how many funds have been allocated from the account for this purpose. For example, this could be implemented as a type of budgetary control (e.g., only allowed to spend up to $50 per month at Best Buy), or could be used by parents/spouses/siblings etc. to control spending (e.g., “my thirteen year old son can access my account to pay for things when he is at the comic book store today, but only up to twenty-five dollars).

In an embodiment, multi-purpose device 7500 may be implemented as gift card usage maximizer 7520C. For example, in an embodiment, a user may have an undetermined amount of value remaining on a gift card and the pay button may illuminate or otherwise change shape, form, status, or similar appearance when the items reach a certain value that is close to the total value of the gift card. For example, the payment bar could be realized in multi-colors, e.g., red and green, and the amount of green in the button indicates how much of the gift card would be utilized by the purchases currently in the shopping cart.

In an embodiment, multi-purpose device 7500 may communicate with a retail store front, e.g., retail store front 7570. In an embodiment, a device with a “pay” button, e.g., device 2121, may interface with the retail store front 7570. In an embodiment, a retail store front 7570 may include a receiving one or more devices configured to have a button that interacts and/or responds to the retail vendor module 7572, a distributing the one or more devices to one or more users upon entry to the retail dressage module 7574, a communicating with the one or more devices to change the button status based on one or more conditions module 7578 (e.g., it is noted that, in an embodiment, this module may be assisted by or controlled entirely by an external third party), and a facilitating one or more transactions in response to button pressing module 7579. In an embodiment, the modules listed above may be performed by a third party that is not the user or the vendor, but may or may not be related to one or both.

Referring again to FIG. 1, in an embodiment, payment initiation module 2210 may include simple payment initiation, which may allow for simple payment of one or more items that the user has indicated. For example, a user wants to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option. The initiation could also be a time-based event, e.g., the start of a movie, or of a round of a fight, or an inning of a baseball game (e.g., for purchase of concessions).

In an embodiment, there may be an augmented reality device 4100. Augmented reality device 4100 may be a device that is owned by the user, and may be associated with the user, e.g., a pair of glasses, or a watch, or it may be a device that is handed out by the vendor, e.g., similarly to how 3D glasses are handed out at movie theaters. Augmented reality device 4100 may include an actual device, and may also include one or more additional devices that support augmented reality device 4100, whether physically located in proximity to the user (e.g., carried by the user in his or her pocket, or worn) or remote to the user.

In an embodiment, augmented reality device 4100 may include duplication module 4110. Duplication module 4110 may be configured to allow a user to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option.

In an embodiment, augmented reality device 4100 may include a modality negotiation module 4210 may include a user payment modality preference retrieving module 4212 configured to retrieve a user payment modality preference. For example, if a user is sitting down in a crowded coffee shop, a user may be reluctant to get up to pay for a bagel, and risk losing her seat. In an embodiment, modality negotiation module 4210 may include vendor modality retrieving module 4214, which may retrieve a vendor payment modality similarly to one of the previously described techniques. For example, the device may detect, or is told, that a store in which the user is located only supports barcode payment or shopping cart modalities, but the user doesn't want to, or is physically incapable of, wait/waiting in a checkout line or self-checkout station. In an embodiment, modality selecting module 4220 may select a modality to carry out the user's request to pay for the item without additional help or input form the user. For example, modality selecting module 4220 may include modality interfacing database module 4222 and modality interfacing database data retrieving module 4224. For example, in an embodiment, if insufficient data is found in the modality interfacing database 4222, then external resources (Internet, Google, an intranet of data from the device manufacturer) may be used to determine how to interface using a modality accepted by the vendor.

In an embodiment, once a modality is selected, and information about how to interface with that modality is attained, then modality interfacing module may interface using the vendor's preferred modality. For example, modality interfacing module 4230 may include, in an embodiment, for example, vendor modality duplication learning module 4232. For example, in the illustrated barcode modality example, the device may retrieve all or a portion of the store's barcode recognition database. It is noted that this retrieval may not involve the vendor, rather, in an embodiment, the device may retrieve this information from a third party that stores these databases, or from various manufacturers of items that the user has selected.

In an embodiment, vendor modality duplication implementing module 4234 may use the data gathered by vendor modality duplication learning module 4232, and use it to implement the data, e.g., in the example, retrieving the barcode of the item the user wants to purchase, e.g., by using an image processing sensor of the device.

In an embodiment, modality interfacing module 4230 also may include vendor modality duplication interfacing module 4236, which may be configured to interact with the vendor. For example, in the illustrated example, the vendor may have a vendor barcode reading device 6000. Vendor barcode reading device 6000 may include a barcode reader 6002, an input/output (which may be as simple as an LED) 6004, a store back-end 6008, and data processing unit 6006 that processes the data read by the barcode reader 6002. In an embodiment, vendor modality duplication interfacing module 4236 interacts with the data processing unit 6006 of the vendor barcode reading device 6000 to deliver the obtained barcode to the vendor, such that the vendor does not distinguish between the transmission and the usual use of the modality, scanning the barcode at the vendor barcode reading device 6000.

In an embodiment, modality interfacing module 4230 also may include a transaction completing module 4238, which completes the transaction and may inform the user.

In an embodiment, a vendor device and/or system 6100 may interact with the system as previously described. In an embodiment, vendor system 6100 may include a vendor payment channel set communicating module 2610. For example, vendor payment channel set communicating module 2610 may include vendor payment channel set broadcasting module 2612, which may be configured to broadcast information, e.g., using vendor payment option set broadcasting module 2612A and vendor payment modality set broadcasting module 2612B.

In an embodiment, vendor payment channel set communicating module 2610 may include one or more of vendor payment communication negotiation with user device module 2614, which may include vendor payment option communication negotiation with user device module 2614A and vendor payment modality communication negotiation with user device module 2614B, vendor payment channel set determining module 2616, and vendor payment channel set monitoring module 2618. In an embodiment, for example, an example vendor may have exemplary vendor payment modality set 2604EX, and exemplary vendor payment option set 2602EX, which have been previously described herein, and which are selected merely for exemplary purposes and are non-limiting.

In an embodiment, vendor device 6100 may include vendor mass payment with variable payment channels system 6200. For example, in various circumstances, a vendor may want to process payments from many users that use a plurality of modalities, e.g., in a movie theater, people may have items that they've purchased, or a set of people might be waiting in line for a new type of tablet device or video game. Vendor variable payment channels system 6200, in an embodiment, may be designed to facilitate all these people's different payment channels (modalities and options) and process them.

In an embodiment, vendor device 6100 may include vendor operation implementation module 2620, which describes how a vendor may implement a similar system as described with respect to user device 120. For example, in an embodiment, vendor operation implementation module 2620 may include vendor detection of a potential transaction module 2622. Module 2622 may detect that a transaction is about to take place, which may be based on vendor equipment, or based on a change in conditions, e.g., a position of a user. For example, module 2622 may be triggered, for example, by a user walking up to a self-checkout window in a grocery store, and hitting “start” on the screen.

In an embodiment, module 2620 may include a vendor payment channel obtaining module 2624. Vendor payment channel obtaining module 2624 may include vendor payment option obtaining module 2624A and vendor payment modality obtaining module 2624B. Vendor payment option obtaining module 2624A and vendor payment modality obtaining module 2624B may work similarly to their counterpart modules in the user device, e.g., vendor payment channel obtaining module 2410, with the exception that the vendor payment channel set may be stored locally.

In an embodiment of the invention, module 2620 may include a user payment channel obtaining module 2626. User payment channel obtaining module 2626 may include user payment option obtaining module 2626A and user payment modality obtaining module 2626B. Similarly to as above, user payment channel obtaining module 2626 may operate in a similar manner to user payment channel obtaining module 2240, except that because the user payment channel data will probably be remote to vendor device 6100, the techniques for obtaining payment channel data in module 2410 also may be used, as described herein.

In an embodiment of the invention, module 2620 may include a payment channel determining module 2628. Payment channel determining module 2628 may select one or more of a payment option and a payment modality, similarly to that which described with reference to module 2501. Also similarly to module 2501, external resources may be used, for example, as detailed in payment option interfacing module 2550 and payment modality interfacing module 2640.

In an embodiment of the invention, module 2620 may include transaction facilitating module using determined payment channel 2629, which may facilitate the transaction using the selected payment channel and payment modality, similarly to as described in module 4000.

In an embodiment of the invention, an application module 3500 may be implemented by a program or application designer. The application may reside at various levels within the device, e.g., the application may be part of the kernel, part of the firmware, part of the operating system, it may be a preinstalled program or an essential program, or an independent program. The application may be implemented as an API or through any other known means of implementing an application, including hardware, software, firmware, programmable hardware, and others.

In an embodiment, an application module 3500 may include or interface with potential transaction detecting module 3510. In an embodiment, potential transaction detecting module 3510 may perform example 3510A of detecting a transaction or a potential for a transaction. In an embodiment, module 3510 may include one or more of device interface monitoring/communicating module 3512, device information gathering module 3514, device social network monitoring module 3516, device third party data regarding potential transaction receiving module 3518, and application communication with vendor facilitating module 3519.

In an embodiment, an application module 3500 may include or interface with a user payment channel obtaining module 3520. In an embodiment, user payment channel obtaining module 3520 may obtain, e.g., generate, receive, retrieve, or otherwise acquire a user payment channel from one or more sources. In an embodiment, user payment channel obtaining module 3520 may obtain a user payment channel set, and select a user payment channel from that user payment channel set. In an embodiment, user payment channel obtaining module 3520 may include one or more of application obtaining from device module 3522, application obtaining from vendor module 3524, application obtaining from third party module 3526, and application inferring module 3528.

In an embodiment, an application module 3500 may include or interface with a vendor payment channel obtaining module 3530. For example, in an embodiment, user vendor payment channel obtaining module 3530 may include obtaining the vendor payment channel from one or more sources 3530A. In an embodiment, vendor payment channel obtaining module 3530 may obtain a vendor payment channel set, and select one or more of a vendor payment option and/or a vendor payment modality, e.g., a vendor payment channel, from the vendor payment channel set. In an embodiment, vendor payment channel obtaining module 3530 may include one or more of application obtaining from device using device I/O module 3532, application obtaining from vendor directly module 3534, application obtaining from third party module 3536, application inferring module 3538, and application receiving vendor information from developer module 3539.

In an embodiment, an application module 3500 may include or interface with a payment channel set union obtaining module 3540, which, in an embodiment, may determine a usable payment channel set 3540A. In an embodiment, the payment channel set union obtaining module 3540 may include one or more of set comparator module 3542 and comparator output analyzing module 3544. In an embodiment, payment channel set union obtaining module 3540 may include or interface with empty set processing module 3560 or selected payment option and modality obtained from union set 3550 (e.g., which may include weighted union set analyzing module 3552), depending on whether there is union between a user payment channel set and a vendor payment channel set. If there is no union between the user payment channel set and the vendor payment channel set, processing moves to one or more of payment option interfacing module 2550 and/or payment modality interfacing module 2640, which are described in more detail elsewhere.

In an embodiment, vendor mass payment with variable payment channels system 6200 may include a device payment channel determining module 6210 configured to communicate with the device to determine a device's payment channel. In an embodiment, vendor mass payment with variable payment channels system 6200 also may include pay now instruction transmitting module 6212, and device payment acceptance module 6214, used to interface with the device modality as previously described. It is noted that the process by which this is carried out, as previously described with respect to user device 120, may take place at the vendor, at the user device, or partially at each of the devices, or using a third party device. In an embodiment, this process is repeated for all of the devices that are detected by the vendor mass payment with variable payment channels system 6200. It is noted that although system 6200 is called vendor mass payment with variable payment channels system 6200, that is merely for illustrative purposes, and in an embodiment, system 6200 may be provided by a third party, e.g., a device manufacturer, that may put limits on what kinds of devices are eligible for the mass payment system (e.g., only Samsung-branded phones are eligible, or only phones communicating on a 4G LTE network are eligible).

In an embodiment of the invention, a device, e.g., device 6500, may be used as a device intermediary, as previously described, with respect to module 2670. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner). In an embodiment, device 6500 may include a condition defined as acceptable for a device to act as an intermediary detecting module 6510. Module 6510 may perform calculations or receive instructions, e.g., from a user, or from a third party with limited agency over the device, that determine when device 6500 is allowed to act as an intermediary. For example, module 6510 may include determining one or more conditions that permit the device to act as an intermediary device for unrelated devices module 6512, which may determine a condition under which device 6500 will act as an intermediary. In an embodiment, module 6510 also may include a detecting one or more of the determined conditions that permit the device to act as an intermediary device for unrelated devices module 6514, which may detect, or be informed of, one or more acceptable conditions. An example of one or more conditions may be that a device is set to act as an intermediary to unrelated devices when the device is located at an upscale shopping mall. Another example may be that a device is set to act as an intermediary to unrelated devices when the device is located at a store that is part of a particular corporate chain. Another example may be that a device is set to act as an intermediary to unrelated devices when the device is located at a store that accepts a particular type of payments (e.g., Google Wallet).

In an embodiment of the invention, device 6500 may include availability as an intermediary informing module 6520, which communicates availability as an intermediary device to a variety of devices through one or more methods. In an embodiment, module 6520 may include one or more of signal broadcasting module 6522 for broadcasting a signal indicating availability as an intermediary that can be picked up by the client device, vendor communication and/or registration module 6524 for contacting the vendor and registering the device as available to perform intermediary work, listening for devices module 6526 for listening to communication involving one or more client devices and/or offering/soliciting as an intermediary, and third party requestor communication module for receiving communication from a non-vendor third party (e.g., a service provider to the vendor or to the client) requesting assistance as an intermediary 6528.

In an embodiment of the invention, device 6500 may include Intermediary acceptance module 6530 which may accept to act as an intermediary for the client device. This module may include intermediary compensation and/or agreement terms negotiating module 6532 and/or client data collecting module 6534. In an embodiment of the invention, device 6500 may include intermediary performance module 6540 for performing intermediary assistance in payment option and/or payment modality between client (user) and vendor.

Referring again to FIG. 1, a manufacturer marketplace may act as an intermediary, as described in step 2554. Such an intermediary may include developer marketplace 6600. For example, a store operated by the operating system manufacturer of the device (e.g., the Microsoft Xbox games store for a device running a Microsoft operating system, e.g., Windows Phone 8.0, receives a request to assist with a transaction, e.g., purchasing a coffee at a coffee shop). The marketplace may collect data regarding payment channels of the coffee shop and the client device that is attempting to purchase the coffee. The marketplace then may provide the payment to the vendor for a transaction, using a payment channel that the client device does not have access to, and then may use its own existing payment channel with the client device to recapture the cost of the transaction.

In an embodiment, marketplace 6600 may include request for payment channel assistance receiving module 6610. For example, an online shopping marketplace (e.g., a transaction facilitator, e.g., the Apple App Store, or Google Play Store) receives a request for assistance with one or more payment channels and/or payment modalities from the client device. In an embodiment, marketplace 6600 may include payment channel data gathering module 6620, which may be configured to gather information about the payment channels used by the client and the vendor, either directly from one or more of the client and/or vendor, or from other devices in the area.

In an embodiment, marketplace 6600 may include a payment channel vendor payment facilitating module 6630 configured to assist in providing payment to the vendor, utilizing one or more tools at its disposal, including possibly third party devices not under the direct control of the vendor, portions of the client device, the vendor device, or other resources.

In an embodiment, marketplace 6600 may include a payment channel client reimbursement facilitating module 6640 configured to, if necessary, if the vendor used one or more payment channels not directly involving the client device, the marketplace uses its payment channels, e.g., which may be preexisting due to the client relationship with the marketplace to collect the cost of the transaction from the client device. In another embodiment, marketplace 6600 may include marketplace as identifier tool module 6635 configured to may work with the vendor to confirm or certify an identity of the client device, in order to facilitate the transaction (e.g., which may be credit or accounts-payable based), rather than actually carry out the transaction.

Referring again to FIG. 1, e.g., FIG. 1C, other alternatives may be incorporated into the system. Some exemplary examples of these alternatives may include a frequent shopper reward application module 2160 that ensures that a user's frequent shopper cards are available as an option, or are automatically applied, a device search engine interface 2350, which goes to a search engine to get instructions to figure out how to interface with a particular payment channel, e.g., option or modality. In an embodiment, the system may include a credit card rewards program maximize module 2130 that may be configured to determine which credit card of a set of credit cards of the user to apply as the payment option to maximize user rewards, which may be based on an efficiency algorithm or a user preference that has been entered into the device.

In an embodiment, the system may include a trusted device voucher module 2354A, which, in an embodiment, in trying to verify the identity of a user, the vendor asks a device it trusts, e.g., a device it authenticates through a different means, to verify that the user device is legitimate. For example, a user's brother might not want to authenticate, or be unable to authenticate, so the user authenticates to the store with the user's device. The store then asks the user to verify that the person is indeed the user's brother. It could be limited to preexisting relationships, or types of relationships, e.g., blood relationships, marriage relationships, and familial relationships, or could use contact list information, or social network information.

In an embodiment, the system may include friendly device search interface 2360 configured to search the area to determine whether there are any devices that share a characteristic with the user device that are in the vicinity.

In an embodiment, the system may include a small business assistance module 2140 configured to figure out whether a user wants to use a corporate card or not, e.g., based on one or more of where the user is located, what store the user is located in, what the user is buying, who the user is with, and the like.

In an embodiment, the system may include a frequent shopper card guaranteed use module 2150 configured to ensure that a user's frequent shopper card number is engaged when the purchase is completed, so that the user gets the credit.

Referring now to FIG. 2, FIG. 2 illustrates an example environment 200 in which the methods, systems, circuitry, articles of manufacture, and computer program products and architecture, in accordance with various embodiments, may be implemented by one or more external coordination devices 240. As shown in FIG. 2A, one or more extrinsic client devices 220, intermediate devices 230, external coordinating devices 240, and vendor devices 280 may communicate via one or more communication networks 240. In an embodiment, intermediate device(s) 230 may include intermediate device “A” 232, intermediate device “B” 234, and/or intermediate device “C” 236. In an embodiment, vendor device 280 may include a vendor payment channel set 204, which may include one or more of a vendor payment modality set 204A and a vendor payment option set 204B. In an embodiment, an extrinsic client device 220 may include a client payment channel set 202. Client payment channel set 202 may include client payment modality set 202A or client payment option set 202B.

In an embodiment, referring again to FIG. 2A, extrinsic client device 220, one or more of intermediate devices 230, and vendor device 280 may be part of exemplary area 201. Exemplary area 201 may be similar to a store front, an area in front of a food truck, a parking lot, a move theater, or the like, e.g., any place where one or more clients and/or devices are present. It is illustrated in FIG. 2A that it is not necessary for an intermediate device, e.g., intermediate device 236, to be present in the exemplary area in order to function as an intermediary device.

Referring again to FIG. 2A, in an embodiment, external coordination device 240 may include one or more of device list 242, vendor list 244, device communication interface 246, and vendor communication interface 248. External coordination device 240 is listed as “external” not because it is necessarily external in temporal location or function, because in an embodiment, it may not be, but because external coordination device 240 is not under the control of vendor device 280, extrinsic client device 220, or intermediate device(s) 230, although any or all of the foregoing may communicate with external coordination device 240, or, in an embodiment, one or more of the foregoing may exclusively communicate with external coordination device 240. External coordination device 240 may be a server, a bank of servers, or a distributed system.

Extrinsic client device 220 may be any electronic device, portable or not, that may be operated by or associated with one or more users. Extrinsic client device 220 is shown as interacting with a user 105. As set forth above, user 105 may be a person, or a group of people, or another entity that mimics the operations of a user. In an embodiment, user 105 may be a computer or a computer-controlled device. Extrinsic client device 220 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

In an embodiment, extrinsic client device 220 may be associated with user/client 105, and vendor device 280 may be associated with vendor 106. In an embodiment, user/client 105 may want to acquire goods and/or services from vendor 106, in what will be referred to throughout this application as a “transaction.” It is noted that “transaction” does not necessarily limit to the payment for a good or service. The transaction may incorporate such things as the user selecting an item, or requesting more information about an item from the vendor.

In an embodiment, user/client 105 and extrinsic client device 220 may facilitate the transaction using a user payment channel 202. A user payment channel 202 may include one or more of a user payment modality 202A and a user payment option 202B. A user payment modality 202 may be a method by which the user 105 compensates the vendor 106 for the one or more goods and services. A user payment option 202B may be a specific type or form of payment by which the user/client 105 attempts to compensate the vendor 106 for the goods or services. Examples of user payment options 202B and user payment modalities 202A are found in FIG. 1.

In an embodiment, vendor 106 and vendor device 280 may facilitate the transaction using a vendor payment channel 204. A vendor payment channel may include one or more of a vendor payment modality 204A and a vendor payment option 204B. A vendor payment modality 204A may be a method by which the user/client 105 compensates the vendor 106 for the one or more goods and services. A vendor payment option 204B may be a specific type or form of payment by which the user/client 105 attempts to compensate the vendor 106 for the goods or services. Examples of vendor payment options 204B and vendor payment modalities 204A are found in FIG. 1.

In an embodiment, the user 105 may wish to use the user payment channel 202 to complete the transaction, regardless of a status of the vendor payment channel 204. In an embodiment, the user/client 105 may desire to not know what the vendor payment channel is, only that the transaction can be completed without the user changing his user payment channel 202 to match the vendor payment channel 204. In an embodiment, there may be no overlap, or an incomplete overlap, between the user payment channel 202 and the vendor payment channel 204. In such instances, the device may select a user payment channel 202, and then perform one or more operations to interface with the vendor payment channel 204. Specific examples of these types of operations will be described in more detail herein with respect to the figures. In an embodiment, the extrinsic client device 220 may use one or more intermediate devices 230 in order to complete the transaction, or may use one or more external coordinating devices 240 that have resources that allow a vendor payment channel to be used by the device, or that can locate resources that allow a vendor payment channel to be used by the device, even if the device does not necessarily support the vendor payment channel 204 directly. In an embodiment, the user may remain unaware that the user payment channel set 202 is not being used for the entire transaction, e.g., the use of other resources and/or devices to complete the transaction may be hidden from the user/client 105. In an embodiment, the device interface may be simplified so that the user 105 only presses a single button to carry out a transaction, and selection of a user payment channel set 202 and execution of the transaction using a vendor payment channel 204 happens seamlessly, and without further input from the user/client 105.

Referring now to FIG. 2B, external coordination device 240 may include an operating system 249 having a kernel 249A. In this context, operating system 249A refers to any hardware, software, firmware, and combination thereof which is considered at the core or baseline of a device. For example, applications that interact directly with hardware may be considered to be part of an operating system. In an embodiment, operating system 249A may be an FPGA, printed circuit board, or other wired device. In an embodiment, operating system 224 may include one or more of Google's Android, Apple's iOS, Microsoft's Windows, various implementations of Linux, and the like. In an embodiment, operating system 249 may include a root menu for one or more televisions, stereo systems, media players, and the like. In an embodiment, operating system 249 may be a “home” or base screen of a device. In an embodiment, operating system 249 may be one or more web servers, e.g., an http server, e.g., Apache Web Server, or Microsoft IIS. In an embodiment, operating system 249 may include server application 249B.

Referring again to FIG. 2B, in an embodiment, external coordination device 240 may include a detection system 247. Detection system 247 may include condition detection system 247A, which may be configured to detect one or more conditions, e.g., a transaction has failed more than once, or a request has been made to use an unsupported payment channel. Detection system 247 may include client device detection system 247B, which may be configured to detect a presence of a feature of one or more client devices. For example, client device detection system 247B may detect that a client device has entered a room, or a particular store, or is waiting in line for a ticket, or has made a request to purchase goods and/or services, and the like.

Referring again to FIG. 2B, in an embodiment, external coordination device 240 may include external resource management system 245. In an embodiment, external resource management system 245 may include external resource contact module 245A, which, in an embodiment, may contact one or more external resources. An external resource may include an intermediate device, e.g., intermediate device 230, or may be a piece of data, e.g., a conversion table, or a vendor code database, or may be an external server, website, or other entity.

In an embodiment, external resource management system 245 may include external resource negotiation module 245B, which may be configured to negotiate with an external resource, e.g., for assistance in facilitating a transaction. For example, external resource negotiation module 245B may set a price, e.g., a flat price or a percentage of the value of the transaction, to be paid to the external resource for its assistance in facilitating the transaction. The negotiated price may be fixed, or may vary depending on the type of assistance in facilitating the transaction.

In an embodiment, external resource management system 245 may include external resource identity obfuscation module 245C. In an embodiment, external resource management system 245C may be used to obscure, obfuscate, conceal, anonymize, alter, or otherwise change or camouflage an identity of the external resource used to facilitate the transaction. Any method may be used to obscure the identity of the external resource, and one or more non-limiting and non-exclusive examples are discussed herein.

Referring again to FIG. 2B, in an embodiment, external coordinating device 240 may include a device memory 243. In an embodiment, device memory 243 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 243 may be separated from the device, e.g., available on a different device on a network, or over the air. For example, in a networked system, or a distributed server system, there may be one or more external coordination devices 280 whose device memory 243 is located at a central server that may be a few feet away or located across an ocean. In an embodiment, external coordinating device 240 may include a device memory 243.

In an embodiment, memory 243 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 243 may be located at a single network site. In an embodiment, memory 243 may be located at multiple network sites, including sites that are distant from each other.

Referring again to FIG. 2B, device memory 243 may include, for example, a device list 242, e.g., list of one or more client devices, e.g., a list of one or more client devices for which resources may be located to assist in facilitation of the transaction. In an embodiment, device memory 243 may include, for example, a vendor list 244, e.g., list of one or more vendors and/or vendor devices, for which one or more resources may be located to assist in facilitation of the transaction. In an embodiment, device memory 243 may include intermediary device identification data 241A, which may track one or more intermediate devices 230, which may or may not be active, and which may have a trait in common, e.g., which may be related to external coordinating device 240.

Referring again to FIG. 2B, in an embodiment, device 280 may include vendor transaction processing system 282. In an embodiment, vendor transaction processing system 282 may include components for processing transactions, including any component that allows the device to interact with its environment. For example, in an embodiment, vendor transaction processing system 282 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like.

Referring again to FIG. 2B, in an embodiment, vendor and extrinsic client management system 241 may be used to communicate with one or more of the vendor 106 and the user/client 105. For example, in an embodiment, vendor and extrinsic client management system 241 may include one or more of extrinsic client device communication interface 246 and vendor communication interface 248.

Referring again to FIG. 2B, FIG. 2B shows a more detailed description of external coordinating device 240. In an embodiment, external coordinating device 240 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single external coordinating device 240, processor 222 may be multiple processors distributed over one or many external coordinating devices 240, which may or may not be configured to operate together. Referring again to FIG. 2B, processor 222 is illustrated as being configured to execute computer readable instructions in order to execute one or more operations described above, and as illustrated in FIGS. 7, 8A-8F, 9A-9D, 10A-10E, and 11A-11B. In an embodiment, processor 222 is designed to be configured to operate as processing module 250, which may include one or more of request for assistance in facilitation of a potential transaction between an extrinsic client configured to use an extrinsic client payment channel and a vendor configured to use a vendor payment channel that is at least partially different than the extrinsic client payment channel acquiring module 252 one or more resources configured to assist in facilitation of the transaction between the extrinsic client and the vendor identifying at least partially based on a characteristic of the one or more resources module 254, transaction data related to one or more of the extrinsic client and the vendor and configured to be used by the identified one or more resources providing to the identified one or more resources module 256, resource data related to the identified one or more resources providing to one or more of the extrinsic client and the vendor module 258.

Referring now to FIG. 3, FIG. 3 illustrates an exemplary implementation of the request for assistance in facilitation of a potential transaction between an extrinsic client configured to use an extrinsic client payment channel and a vendor configured to use a vendor payment channel that is at least partially different than the extrinsic client payment channel acquiring module 252. As illustrated in FIG. 3, the request for assistance in facilitation of a potential transaction between an extrinsic client configured to use an extrinsic client payment channel and a vendor configured to use a vendor payment channel that is at least partially different than the extrinsic client payment channel acquiring module may include one or more sub-logic modules in various alternative implementations and embodiments. For example, as shown in FIG. 3, e.g., FIG. 3A, in an embodiment, module 252 may include request for assistance in facilitation of a potential transaction between an extrinsic client configured to use an extrinsic client payment channel and a vendor configured to use a vendor payment channel that is at least partially different than the extrinsic client payment channel receiving module 302. In an embodiment, module 302 may include request for assistance in facilitation of a potential transaction between an extrinsic client configured to use an extrinsic client payment channel and a vendor configured to use a vendor payment channel that is at least partially different than the extrinsic client payment channel receiving from the vendor module 304. In an embodiment, module 304 may include request for assistance in facilitation of a potential transaction between an extrinsic client configured to use an extrinsic client payment channel and a vendor configured to use a vendor payment channel that is at least partially different than the extrinsic client payment channel receiving from a vendor that is remote from a device that receives the request module 306. In an embodiment, module 306 may include request for assistance in facilitation of a potential transaction between an extrinsic client configured to use an extrinsic client payment channel that includes one or more of an extrinsic client payment option and an extrinsic client payment modality and a vendor configured to use a vendor payment channel that includes one or more of a vendor payment option and a vendor payment modality and that is at least partially different than the extrinsic client payment channel receiving from a vendor that is remote from a device that receives the request module 308.

Referring again to FIG. 3, e.g., FIG. 3B, in an embodiment, module 252 may include request for assistance in facilitation of a potential transaction between an extrinsic client configured to use an extrinsic client payment channel and a vendor configured to use a vendor payment channel that is at least partially different than the extrinsic client payment channel receiving from the extrinsic client module 310. In an embodiment, module 310 may include request for assistance in facilitation of a potential transaction between an extrinsic client configured to use an extrinsic client payment channel and a vendor configured to use a vendor payment channel that is at least partially different than the extrinsic client payment channel receiving from an extrinsic client that has a relationship with an entity configured to receive the request module 312. In an embodiment, module 312 may include one or more of request for assistance in facilitation of a potential transaction between an extrinsic client configured to use an extrinsic client payment channel and a vendor configured to use a vendor payment channel that is at least partially different than the extrinsic client payment channel receiving from an extrinsic client for which one or more services are configured to be provided module 314 and request for assistance in facilitation of a potential transaction between an extrinsic client configured to use an extrinsic client payment channel and a vendor configured to use a vendor payment channel that is at least partially different than the extrinsic client payment channel receiving from an extrinsic client for which a marketplace is configured to be provided module 316.

Referring again to FIG. 3, e.g., FIG. 3C, in an embodiment, module 252 may include module 310, as previously described. In an embodiment, module 310 may include request for assistance in facilitation of a potential transaction between an extrinsic client configured to use an extrinsic client payment channel and a vendor configured to use a vendor payment channel that is at least partially different than the extrinsic client payment channel receiving from an extrinsic client device associated with the extrinsic client module 318. In an embodiment, module 318 may include one or more of request for assistance in facilitation of a potential transaction between an extrinsic client configured to use an extrinsic client payment channel and a vendor configured to use a vendor payment channel that is at least partially different than the extrinsic client payment channel receiving from an extrinsic client device that has a particular property and that is associated with the extrinsic client module 320. In an embodiment, module 320 may include request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a particular application and that is associated with the extrinsic client module 322. In an embodiment, module 322 may include one or more of request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a proprietary application and that is associated with the extrinsic client module 324. In an embodiment, module 324 may include request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a like-finding proprietary application and that is associated with the extrinsic client module 326.

Referring again to FIG. 3, e.g., FIG. 3D, in an embodiment, module 252 may include one or more of request for assistance in facilitation of a potential transaction between an extrinsic client configured to use an extrinsic client payment channel and a vendor configured to use a vendor payment channel that is at least partially different than the extrinsic client payment channel receiving from an uninvolved entity module 328, request for assistance in facilitation of a potential transaction between an extrinsic client configured to use an extrinsic client payment channel and a vendor configured to use a vendor payment channel that is at least partially different than the extrinsic client payment channel receiving from an intermediary device module 334, and offer to assist in the facilitation of the potential between the extrinsic client and the vendor receiving from the intermediary device module 336. In an embodiment, module 328 may include one or more of request for assistance in facilitation of a potential transaction between an extrinsic client configured to use an extrinsic client payment channel and a vendor configured to use a vendor payment channel that is at least partially different than the extrinsic client payment channel receiving from an application developer entity module 330 and request for assistance in facilitation of a potential transaction between an extrinsic client configured to use an extrinsic client payment channel and a vendor configured to use a vendor payment channel that is at least partially different than the extrinsic client payment channel receiving from an extrinsic device component developer module 332. In an embodiment, module 334 may include request for assistance in facilitation of a potential transaction between the extrinsic client and the vendor receiving from an intermediary device related to the extrinsic device module 338. In an embodiment, module 338 may include request for assistance in facilitation of a potential transaction between the extrinsic client and the vendor receiving from an intermediary device configured to communicate over a same network as the extrinsic device module 340.

Referring again to FIG. 3, e.g., FIG. 3E, in an embodiment, module 252 may include request for assistance in facilitation of a potential transaction between an extrinsic client configured to use an extrinsic client payment channel and a vendor configured to use a vendor payment channel that is at least partially different than the extrinsic client payment channel acquiring using a proprietary communication channel module 342. In an embodiment, module 342 may include one or more of request for assistance in facilitation of a potential transaction between an extrinsic client configured to use an extrinsic client payment channel and a vendor configured to use a vendor payment channel that is at least partially different than the extrinsic client payment channel acquiring using a communication channel available only to one or more devices having a particular type module 344 and request for assistance in facilitation of a potential transaction between an extrinsic client configured to use an extrinsic client payment channel and a vendor configured to use a vendor payment channel that is at least partially different than the extrinsic client payment channel acquiring using a closed access network module 346.

Referring now to FIG. 4, FIG. 4 illustrates an exemplary implementation of one or more resources configured to assist in facilitation of the transaction between the extrinsic client and the vendor identifying at least partially based on a characteristic of the one or more resources module 254. As illustrated in FIG. 4, the one or more resources configured to assist in facilitation of the transaction between the extrinsic client and the vendor identifying at least partially based on a characteristic of the one or more resources module 254 may include one or more sub-logic modules in various alternative implementations and embodiments. For example, as shown in FIG. 4, e.g., FIG. 4A, in an embodiment, module 254 may include intermediary device configured to assist in facilitation of the transaction between the extrinsic client and the vendor identifying at least partially based on a characteristic of the one or more resources module 402. In an embodiment, module 402 may include one or more of cellular telephone device with identified feature configured to assist in facilitation of the transaction between the extrinsic client and the vendor identifying at least partially based on a characteristic of the one or more resources module 404, intermediary device configured to assist in facilitation of the transaction between the extrinsic client and the vendor identifying at least partially based on a proximity of the intermediary device to one or more of the extrinsic client and the vendor module 406, intermediary device configured to assist in facilitation of the transaction between the extrinsic client and the vendor identifying at least partially based on a proximity of the intermediary device to the vendor module 408, and intermediary device configured to assist in facilitation of the transaction between the extrinsic client and the vendor identifying at least partially based on a capability of the intermediary device module 410. In an embodiment, module 410 may include intermediary device configured to assist in facilitation of the transaction between the extrinsic client and the vendor identifying at least partially based on an ability to process at least a portion of one or more of the vendor payment channel and the extrinsic client payment channel module 412. In an embodiment, module 412 may include intermediary device configured to assist in facilitation of the transaction between the extrinsic client and the vendor identifying at least partially based on an ability to process the vendor payment channel and the extrinsic client payment channel module 414.

Referring again to FIG. 4, e.g., FIG. 4B, in an embodiment, module 254 may include module 402, as previously described. In an embodiment, module 402 may include one or more of intermediary device configured to assist in facilitation of the transaction between the extrinsic client and the vendor identifying at least partially based on an intermediary device type module 416 and intermediary device configured to assist in facilitation of the transaction between the extrinsic client and the vendor identifying at least partially based on one or more applications resident in a memory of the intermediary device module 420. In an embodiment, module 416 may include intermediary device configured to assist in facilitation of the transaction between the extrinsic client and the vendor identifying at least partially based on a device manufacturer identity module 418.

Referring again to FIG. 4, e.g., FIG. 4C, in an embodiment, module 254 may include one or more of list of one or more resources configured to assist in the facilitation of the potential transaction between the extrinsic client and the vendor acquiring module 422 and particular resource from the acquired list of one or more resources selecting at least partly based on a particular resource characteristic module 424. In an embodiment, module 422 may include one or more of a list of one or more resources having a common property and that are configured to assist in the facilitation of the potential transaction between the extrinsic client and the vendor acquiring module 426 and a list of one or more resources configured to assist in the facilitation of the potential transaction between the extrinsic client and the vendor generating through a monitor of one or more known devices module 434. In an embodiment, module 426 may include one or more of a list of one or more resources that are one or more devices having a common manufacturer and that are configured to assist in the facilitation of the potential transaction between the extrinsic client and the vendor acquiring module 428, a list of one or more resources that are one or more devices having a common operating system and that are configured to assist in the facilitation of the potential transaction between the extrinsic client and the vendor acquiring module 430, and a list of one or more resources that are one or more devices that are connected to a same communication network and that are configured to assist in the facilitation of the potential transaction between the extrinsic client and the vendor acquiring module 432 In an embodiment, module 434 may include one or more of list of one or more resources configured to assist in the facilitation of the potential transaction between the extrinsic client and the vendor generating through a poll of one or more marketplace-accessed devices module 436 and list of one or more resources configured to assist in the facilitation of the potential transaction between the extrinsic client and the vendor generating through a poll of one or more application-installed devices module 438.

Referring now to FIG. 5, FIG. 5 illustrates an exemplary implementation of transaction data related to one or more of the extrinsic client and the vendor and configured to be used by the identified one or more resources providing to the identified one or more resources module 256. As illustrated in FIG. 5, the transaction data related to one or more of the extrinsic client and the vendor and configured to be used by the identified one or more resources providing to the identified one or more resources module 256 may include one or more sub-logic modules in various alternative implementations and embodiments. For example, as shown in FIG. 5, e.g., FIG. 5A, in an embodiment, module 256 may include one or more of location data related to one or more of the extrinsic client and the vendor and configured to be used by the identified one or more resources providing to the identified one or more resources module 502 and transaction data related to an extrinsic client device associated with the extrinsic client configured to be used by the identified one or more resources providing to the identified one or more resources module 508. In an embodiment, module 502 may include location data of an extrinsic client device related to the extrinsic client and configured to be used by the identified one or more resources providing to the identified one or more resources module 504. In an embodiment, module 504 may include internet protocol address data of an extrinsic client device related to the extrinsic client and configured to be used by the identified one or more resources providing to the identified one or more resources module 506.

Referring again to FIG. 5, e.g., FIG. 5B, in an embodiment, module 256 may include one or more of transaction data related to the vendor and configured to be used by the identified one or more resources providing to the identified one or more resources module 510 and transaction data regarding a property of the potential transaction and configured to be used by the identified one or more resources providing to the identified one or more resources module 514. In an embodiment, module 510 may include transaction data related to the vendor including an amount of vendor-offered compensation for facilitation service and configured to be used by the identified one or more resources providing to the identified one or more resources module 512. In an embodiment, module 514 may include transaction data regarding a value of the potential transaction and configured to be used by the identified one or more resources providing to the identified one or more resources module 516.

Referring again to FIG. 5, e.g., FIG. 5C, in an embodiment, module 256 may include instruction for assistance in use of the extrinsic payment channel with the vendor payment channel providing to the identified one or more resources module 518. In an embodiment, module 518 may include one or more of instruction for adapting the extrinsic payment channel for use with the vendor payment channel providing to the identified one or more resources module 520, instruction for converting data regarding the extrinsic payment channel into data for use with the vendor payment channel providing to the identified one or more resources module 522, instruction for a collection of payment from the extrinsic client through use of the extrinsic client payment channel providing module 524, instruction for a dispersal of the payment to the vendor through use of the vendor payment channel providing module 526, and instruction for application of the data gathered in the collection of payment from the extrinsic client through use of the extrinsic client payment channel to the dispersal of payment to the vendor through use of the vendor payment channel providing module 528.

Referring again to FIG. 5, e.g., FIG. 5D, in an embodiment, module 256 may include transaction data related to one or more of the extrinsic client and the vendor and configured to be used by an intermediary device providing to the intermediary device module 530. In an embodiment, module 530 may include transaction data related to one or more of the extrinsic client and the vendor and configured to be used by an intermediary device having a particular property providing to the intermediary device module 532. In an embodiment, module 534 may include transaction data related to one or more of the extrinsic client and the vendor and configured to be used by an intermediary device having a particular property in common with an extrinsic client device associated with the extrinsic client providing to the intermediary device module 536. In an embodiment, module 536 may include one or more of transaction data related to one or more of the extrinsic client and the vendor and configured to be used by an intermediary device having a particular proprietary application resident in memory that is also present on an extrinsic client device associated with the extrinsic client providing to the intermediary device module 536 and transaction data related to one or more of the extrinsic client and the vendor and configured to be used by an intermediary device having a similar configuration as an extrinsic client device associated with the extrinsic client providing to the intermediary device module 538.

Referring again to FIG. 5, e.g., FIG. 5E, in an embodiment, module 256 may include module 530, as previously described. In an embodiment, module 530 may include one or more of transaction data related to one or more of the extrinsic client and the vendor and configured to be used by the intermediary device providing to the intermediary device that is anonymous to one or more of the extrinsic client and the vendor module 540, transaction data related to one or more of the extrinsic client and the vendor and configured to be used by the intermediary device providing to the intermediary device for which the identity is hidden from one or more of the extrinsic client and the vendor module 542, and transaction data related to one or more of the extrinsic client and the vendor and configured to be used by the intermediary device providing to the intermediary device configured to communicate with an extrinsic client device associated with the extrinsic client through access to a proprietary communication channel module 544.

Referring now to FIG. 6, FIG. 6 illustrates an exemplary implementation of resource data related to the identified one or more resources providing to one or more of the extrinsic client and the vendor module 258. As illustrated in FIG. 6, the resource data related to the identified one or more resources providing to one or more of the extrinsic client and the vendor module 258 may include one or more sub-logic modules in various alternative implementations and embodiments. For example, as shown in FIG. 6A, in an embodiment, module 258 may include one or more of contact instruction for contact of intermediary device configured to assist in facilitation of the potential transaction providing to one or more of the extrinsic client and the vendor module 602, credential data for a gain of access to an intermediary device configured to assist in facilitation of the potential transaction providing to one or more of the extrinsic client and the vendor module 606, identifying data for verifying an identity of an intermediary device configured to assist in facilitation of the potential transaction providing to one or more of the extrinsic client and the vendor module 608, intermediary device configured to assist in facilitation of the potential transaction identification data acquiring module 610, acquired intermediary device identification data anonymizing into anonymous intermediary device data module 612, and anonymous intermediary device data providing to one or more of the extrinsic client and the vendor module 614. In an embodiment, module 602 may include internet protocol address and authentication phrase for contact of intermediary device configured to assist in facilitation of the potential transaction providing to one or more of the extrinsic client and the vendor module 604. In an embodiment, module 612 may include one or more of acquired intermediary device identification data altering through removal of data configured to uniquely identify the intermediary device to one or more of the extrinsic client and the vendor module 616 and acquired intermediary device identification data replacement with protected value configured to obscure data configured to uniquely identify the intermediary device to one or more of the extrinsic client and the vendor module 618.

Referring again to FIG. 6, e.g., FIG. 6B, in an embodiment, module 258 may include offer to facilitate the potential transaction on behalf of an intermediary device configured to assist in facilitation of the potential transaction providing to one or more of the extrinsic client and the vendor module 620.

Referring now to FIG. 7, FIG. 7 shows operation 700, e.g., an example operation of a device 220 operating in an environment 200. In an embodiment, operation 700 may include operation 702 depicting acquiring a request for assistance in a facilitation of a potential transaction between an extrinsic client configured to use an extrinsic client payment channel and a vendor configured to use a vendor payment channel that is at least partially different than the extrinsic client payment channel. For example, FIG. 2, e.g., FIG. 2B, shows request for assistance in facilitation of a potential transaction between an extrinsic client configured to use an extrinsic client payment channel and a vendor configured to use a vendor payment channel that is at least partially different than the extrinsic client payment channel acquiring module 252 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a request for assistance (e.g., attempt to aid in, whether successful or not) in facilitation (e.g., one or more steps in a furtherance of, whether successful or not, including actions that record steps or create other steps, and actions that ultimately result in an unintended result) of the potential transaction (e.g., an exchange of a form of compensation for goods and/or services, whether it actually occurs or not, at any stage, including preparation, selection of an item, verification of a price, verification of an identity, and equivalents) between an extrinsic client (e.g., a customer, a person, a device, a user, and any associated hardware (e.g., phone, tablet, laptop, wearable device, and the like)) configured to use an extrinsic client payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available) used by the extrinsic client and/or an extrinsic client-associated device) and a vendor (e.g., a seller of goods and/or services in exchange for compensation, and/or any devices or systems associated with said seller of goods and/or services in exchange for compensation) configured to use a vendor payment channel (e.g., one or more of a vendor payment modality (e.g., a method of performing the exchange, a medium by which the exchange takes place, a facilitator of exchange of compensation, and equivalents, that the vendor has available to him or her) and a vendor payment option (e.g., a form of a medium of exchange, e.g., money, currency, credit, and equivalents) that is at least partially different than the extrinsic client payment channel (e.g., at least a portion of the extrinsic client payment channel is not the same as the vendor payment channel).

Referring again to FIG. 7, operation 700 may include operation 704 depicting identifying one or more resources configured to assist in the facilitation of the potential transaction between the extrinsic client and the vendor, said identifying at least partially based on a characteristic of the one or more resources. For example, FIG. 2, e.g., FIG. 2B, shows one or more resources configured to assist in facilitation of the transaction between the extrinsic client and the vendor identifying at least partially based on a characteristic of the one or more resources module 254 identifying (e.g., locating, finding, selecting, acquiring information about, establishing communication with, verifying, authenticating, recognizing, and/or choosing) one or more resources (e.g., a “resource” can be a device or set of devices, whether related to parties to the transaction or not, including personal devices carried by other users, including one or more laptops, tablets, cellular telephones, wearable computers, and the like; a “resource” can also refer to data, e.g., a table that assists in conversion from one payment channel to another, or a database from which data that can assist in facilitation of the transaction is retrieved) configured to (e.g., designed to be carried out, or designed in a manner that makes capable of being carried out) assist (e.g., attempt to aid in, whether successful or not) in the facilitation (e.g., one or more steps in a furtherance of, whether successful or not, including actions that record steps or create other steps, and actions that ultimately result in an unintended result) of the potential transaction (e.g., an exchange of a form of compensation for goods and/or services, whether it actually occurs or not, at any stage, including preparation, selection of an item, verification of a price, verification of an identity, and equivalents) executed, performed, take a step or measure toward, schedule the performance of, instruct an entity to perform, and the like, including one or more portions of carrying out) between the extrinsic client (e.g., a customer, a person, a device, a user, and any associated hardware (e.g., phone, tablet, laptop, wearable device, and the like)) and the vendor (e.g., a seller of goods and/or services in exchange for compensation, and/or any devices or systems associated with said seller of goods and/or services in exchange for compensation) identifying (e.g., locating, selecting, acquiring information about, establishing communication with, verifying, authenticating, recognizing, and/or choosing) at least partially based on a characteristic (e.g., an environment-independent property and/or an environment-dependent property, e.g., a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor, or a particular position, proximity to the event, acceleration, velocity, and an ambient condition, or a particular property of data, or a format of the data, and the like) of the one or more resources (e.g., a “resource” can be a device or set of devices, whether related to parties to the transaction or not, including personal devices carried by other users, including one or more laptops, tablets, cellular telephones, wearable computers, and the like; a “resource” can also refer to data, e.g., a table that assists in conversion from one payment channel to another, or a database from which data that can assist in facilitation of the transaction is retrieved).

Referring again to FIG. 7, operation 700 may include operation 706 depicting providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction. For example, FIG. 2, e.g., FIG. 2B, shows transaction data related to one or more of the extrinsic client and the vendor and configured to be used by the identified one or more resources providing to the identified one or more resources module 256 providing (e.g., supplying, transmitting, providing instructions for receiving, retrieving, and/or acquiring, broadcasting, presenting, offering, supporting, maintaining, and/or accommodating) potential transaction data (e.g., data that is related to the potential transaction or one of the parties or facilitators of the potential transaction) related to (e.g., the data has a property (e.g., is about, comes from, is to be delivered to) that connects it to the potential transaction or one of the parties or facilitators of the potential transaction) one or more of the extrinsic client (e.g., a customer, a person, a device, a user, and any associated hardware (e.g., phone, tablet, laptop, wearable device, and the like)) configured to use an extrinsic client payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available) used by the extrinsic client and/or an extrinsic client-associated device) and the vendor (e.g., a seller of goods and/or services in exchange for compensation, and/or any devices or systems associated with said seller of goods and/or services in exchange for compensation) configured to use the vendor payment channel (e.g., one or more of a vendor payment modality (e.g., a method of performing the exchange, a medium by which the exchange takes place, a facilitator of exchange of compensation, and equivalents, that the vendor has available to him or her) and a vendor payment option (e.g., a form of a medium of exchange, e.g., money, currency, credit, and equivalents), to the identified one or more resources (e.g., a “resource” can be a device or set of devices, whether related to parties to the transaction or not, including personal devices carried by other users, including one or more laptops, tablets, cellular telephones, wearable computers, and the like; a “resource” can also refer to data, e.g., a table that assists in conversion from one payment channel to another, or a database from which data that can assist in facilitation of the transaction is retrieved), said potential transaction data (e.g., data that is related to the potential transaction or one of the parties or facilitators of the potential transaction) related to (e.g., the data has a property (e.g., is about, comes from, is to be delivered to) that connects it to the potential transaction or one of the parties or facilitators of the potential transaction) configured to be used (e.g., designed or intended, whether successful or not, and whether intentional or not, to be applied, utilized, read, managed, handled, manipulated, put to use in the furtherance of, employed in the pursuit of, and the like) to facilitate (e.g., to take one or more steps in a furtherance of, whether successful or not, including actions that record steps or create other steps, and actions that ultimately result in an unintended result) of the potential transaction (e.g., an exchange of a form of compensation for goods and/or services, whether it actually occurs or not, at any stage, including preparation, selection of an item, verification of a price, verification of an identity, and equivalents) executed, performed, take a step or measure toward, schedule the performance of, instruct an entity to perform, and the like, including one or more portions of carrying out).

Referring again to FIG. 7, operation 700 may include operation 708 depicting providing resource data to one or more of the extrinsic client and the vendor, said resource data related to the identified one or more resources. For example, FIG. 2, e.g., FIG. 2B, shows resource data related to the identified one or more resources providing to one or more of the extrinsic client and the vendor module 258 providing (e.g., supplying, transmitting, providing instructions for receiving, retrieving, and/or acquiring, broadcasting, presenting, offering, supporting, maintaining, and/or accommodating) resource data (e.g., data related to the identified one or more resources (e.g., a “resource” can be a device or set of devices, whether related to parties to the transaction or not, including personal devices carried by other users, including one or more laptops, tablets, cellular telephones, wearable computers, and the like; a “resource” can also refer to data, e.g., a table that assists in conversion from one payment channel to another, or a database from which data that can assist in facilitation of the transaction is retrieved)) to one or more of the extrinsic client (e.g., a customer, a person, a device, a user, and any associated hardware (e.g., phone, tablet, laptop, wearable device, and the like)) and the vendor (e.g., a seller of goods and/or services in exchange for compensation, and/or any devices or systems associated with said seller of goods and/or services in exchange for compensation), said resource data related to the identified resources (e.g., a “resource” can be a device or set of devices, whether related to parties to the transaction or not, including personal devices carried by other users, including one or more laptops, tablets, cellular telephones, wearable computers, and the like; a “resource” can also refer to data, e.g., a table that assists in conversion from one payment channel to another, or a database from which data that can assist in facilitation of the transaction is retrieved).

FIGS. 8A-8C depict various implementations of operation 702, depicting acquiring a request for assistance in a facilitation of a potential transaction between an extrinsic client configured to use an extrinsic client payment channel and a vendor configured to use a vendor payment channel that is at least partially different than the extrinsic client payment channel according to embodiments. Referring now to FIG. 8A, operation 702 may include operation 802 depicting receiving a request for assistance in the facilitation of the potential transaction between the extrinsic client configured to use the extrinsic payment channel and the vendor configured to use the vendor payment channel that is at least partially different than the extrinsic client payment channel. For example, FIG. 3, e.g., FIG. 3A, shows request for assistance in facilitation of a potential transaction between an extrinsic client configured to use an extrinsic client payment channel and a vendor configured to use a vendor payment channel that is at least partially different than the extrinsic client payment channel receiving module 302 receiving a request for assistance (e.g., the taking of one or more steps in the aiding or abetting of) the facilitation of the potential transaction (e.g., paying for gasoline at a gas pump) between the extrinsic client (e.g., a user buying the coffee drink) configured to use the extrinsic client payment channel (e.g., a client payment modality of credit card verification with swipe only) and the vendor configured to use the vendor payment channel (e.g., a vendor payment modality of payment modality of credit card verification with billing zip code) that is at least partially different than the extrinsic client payment channel (e.g., one or more of an extrinsic client payment option and an extrinsic client payment modality are different than a vendor payment option and a vendor payment modality).

Referring again to FIG. 8A, operation 802 may include operation 804 depicting receiving a request, from the vendor, for assistance in the facilitation of the potential transaction between the extrinsic client configured to use the extrinsic payment channel and the vendor configured to use the vendor payment channel that is at least partially different than the extrinsic client payment channel. For example, FIG. 3, e.g., FIG. 3A, shows request for assistance in facilitation of a potential transaction between an extrinsic client configured to use an extrinsic client payment channel and a vendor configured to use a vendor payment channel that is at least partially different than the extrinsic client payment channel receiving from the vendor module 304 receiving a request (e.g., in the form of a data transmission), from the vendor (e.g., a big-box retail store), for assistance in the facilitation of the potential transaction (e.g., purchasing a laptop computer peripheral accessory) between the extrinsic client (e.g., a shopper) configured to use the extrinsic client payment channel (e.g., an extrinsic client payment modality of one-dimensional barcode reading) and the vendor (e.g., the big-box retail store) configured to use the vendor payment channel (e.g., a vendor payment modality of color bar code reading) that is at least partially different than the extrinsic client payment channel.

Referring again to FIG. 8A, operation 804 may include operation 806 depicting receiving a request, from a vendor that is remotely located from a device configured to receive the request from the vendor, for assistance in the facilitation of the potential transaction between the extrinsic client configured to use the extrinsic client payment channel and the vendor configured to use the extrinsic payment channel and the vendor configured to use the vendor payment channel that is at least partially different than the extrinsic client payment channel. For example, FIG. 3, e.g., FIG. 3A, shows request for assistance in facilitation of a potential transaction between an extrinsic client configured to use an extrinsic client payment channel and a vendor configured to use a vendor payment channel that is at least partially different than the extrinsic client payment channel receiving from a vendor that is remote from a device that receives the request module 306 receiving a request, from a vendor that is remotely located from a device configured to receive the request from the vendor (e.g., the external coordination device), for assistance in the facilitation of the potential transaction (e.g., a purchase of a set of customized team jerseys for the Ichi Bang Studios basketball team) between the extrinsic client configured to use an extrinsic client payment channel (e.g., an extrinsic client payment modality of credit card verification with signature, and an extrinsic client payment option of credit card gamma) and the vendor (e.g., the sporting goods store with the row of cash registers) configured to use the vendor payment channel (e.g., one vendor payment option (e.g., the frequent shopper rewards card) and one vendor payment modality (e.g., virtual currency transaction) that is at least partially different than the extrinsic client payment channel (e.g., the extrinsic client payment modality of credit card verification with signature, and the extrinsic client payment option of credit card gamma).

Referring again to FIG. 8A, operation 806 may include operation 808 depicting receiving a request, from a vendor sporting goods store, for assistance in the facilitation of a potential transaction to pay for a piece of athletic equipment between an extrinsic client configured to use the extrinsic client payment channel that includes an extrinsic client payment modality of a credit card tap with near-field communication and an extrinsic client payment option of credit card type gamma and the vendor sporting goods store configured to use the vendor payment channel that includes a vendor payment modality of credit card swipe with signature and a vendor payment option of credit card type gamma. For example, FIG. 3, e.g., FIG. 3A, shows request for assistance in facilitation of a potential transaction between an extrinsic client configured to use an extrinsic client payment channel that includes one or more of an extrinsic client payment option and an extrinsic client payment modality and a vendor configured to use a vendor payment channel that includes one or more of a vendor payment option and a vendor payment modality and that is at least partially different than the extrinsic client payment channel receiving from a vendor that is remote from a device that receives the request module 308 receiving a request, from a vendor sporting goods store, for assistance in the facilitation of a potential transaction to pay for a piece of athletic equipment between an extrinsic client configured to use the extrinsic client payment channel that includes an extrinsic client payment modality of a credit card tap with near-field communication and an extrinsic client payment option of credit card type gamma and the vendor sporting goods store configured to use the vendor payment channel that includes a vendor payment modality of credit card swipe with signature and a vendor payment option of credit card type gamma.

Referring now to FIG. 8B, operation 702 may include operation 810 depicting receiving, from the extrinsic client, a request for assistance in a facilitation of the potential transaction between the extrinsic client configured to use the extrinsic client payment channel and the vendor configured to use the vendor payment channel that is at least partially different than the extrinsic client payment channel. For example, FIG. 3, e.g., FIG. 3B, shows request for assistance in facilitation of a potential transaction between an extrinsic client configured to use an extrinsic client payment channel and a vendor configured to use a vendor payment channel that is at least partially different than the extrinsic client payment channel receiving from the extrinsic client module 310 receiving, from the extrinsic client (e.g., a person shopping for groceries and using a smart grocery cart that recognizes items placed inside it and keeps a running tab of the value of the items inside the cart), a request for assistance in a facilitation of a potential transaction (e.g., purchasing groceries at the grocery store) between the extrinsic client (e.g., the shopper) configured to use an extrinsic client payment channel (e.g., an extrinsic client payment option and an extrinsic client payment modality, e.g., credit card alpha as the extrinsic client payment option and speech recognition as the extrinsic client payment modality) and the vendor (e.g., the grocery store cashier) configured to use the vendor payment channel (e.g., a vendor payment modality of barcode recognition) that is at least partially different than the extrinsic client payment channel (e.g., the extrinsic client payment option and the extrinsic client payment modality, e.g., credit card alpha as the extrinsic client payment option and speech recognition as the extrinsic client payment modality).

Referring again to FIG. 8B, operation 810 may include operation 812 depicting receiving, from the extrinsic client with which an entity configured to receive the request has a relationship, a request for assistance in facilitation of a potential transaction between the extrinsic client configured to use the extrinsic client payment channel and the vendor configured to use the vendor payment channel that is at least partially different than the extrinsic client payment channel. For example, FIG. 3, e.g., FIG. 3B, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client that has a relationship with an entity configured to receive the request module 312 receiving, from an extrinsic client (e.g., a patron at a restaurant that is carrying a smartphone device) with which an entity configured to receive the request (e.g., the external coordination device) has a relationship (e.g., the external coordination device configured to receive the request has communicated with the smartphone device belonging to the extrinsic client at least once previously, or the external coordination device has stored data regarding the smartphone device, or the smartphone device has been configured from the factory to contact the external coordination device), a request for assistance in facilitation of a potential transaction (e.g., paying for dinner) between the extrinsic client configured to use the extrinsic client payment channel (e.g., an extrinsic client payment option, e.g., Gamma Bank branded debit card, and an extrinsic client payment modality, e.g., card verification with PIN entry) and the vendor configured to use the vendor payment channel (e.g., a vendor payment modality of device authentication using wireless network) that is at least partially different from the extrinsic client payment channel (e.g., an extrinsic client payment option, e.g., Gamma Bank branded debit card, and an extrinsic client payment modality, e.g., card verification with PIN entry).

Referring again to FIG. 8B, operation 812 may include operation 814 depicting receiving, from the extrinsic client for which one or more services are provided, a request for assistance in facilitation of the potential transaction between the extrinsic client configured to use the extrinsic client payment channel and the vendor configured to use the vendor payment channel that is at least partially different than the extrinsic client payment channel. For example, FIG. 3, e.g., FIG. 3B, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client for which one or more services are configured to be provided module 314 receiving, from an extrinsic client (e.g., a smartphone device carried by a user who is shopping at a bulk discount store) for which one or more services (e.g., cellular services, game services, application services, or any combination thereof) are provided (e.g., provided to the smartphone device for use by the device or by the user of the device, depending on the service), a request for assistance in facilitation of the potential transaction (e.g., placing the order for and paying for the user's coffee drink without getting up to the register) between the extrinsic client (e.g., the laptop device) having the particular characteristic (e.g., the laptop has subscribed to the “pay-away” service and is running the program currently), and the vendor configured to use the vendor payment channel (e.g., a vendor payment option of American Express card and a vendor payment modality of RFID-based credit card tap-and-pay).

Referring again to FIG. 8B, operation 812 may include operation 816 depicting receiving, from the extrinsic client for which a marketplace is provided, a request for assistance in facilitation of the potential transaction between the extrinsic client configured to use the extrinsic client payment channel and the vendor configured to use the vendor payment channel that is at least partially different than the extrinsic client payment channel. For example, FIG. 3, e.g., FIG. 3B, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client for which a marketplace is configured to be provided module 316 receiving, from an extrinsic client (e.g., a tablet device carried by a user to a grocery store) for which a marketplace (e.g., an online store where the tablet user can login to her account and purchase games, movies, music, books, or other consumable media) is provided, a request for assistance in facilitation of the potential transaction (e.g., paying the user's bar tab) between the extrinsic client (e.g., the person at the crowded bar carrying the smartphone) and the vendor (e.g., the bar, or the bartender) configured to use the vendor payment channel (e.g., a vendor payment option of cash and traveler's checks and a vendor payment modality of physical examination of the tender) that is at least partially different from the extrinsic client payment channel (e.g., an extrinsic client payment option of “indirect device authentication via an application store service”).

Referring now to FIG. 8C, operation 810 may include operation 818 depicting receiving, from the extrinsic client device associated with the extrinsic client, a request for assistance in facilitation of the potential transaction between the extrinsic client and the vendor configured to use the vendor payment channel that is at least partially different from the extrinsic client payment channel. For example, FIG. 3, e.g., FIG. 3C, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client device associated with the extrinsic client module 318 receiving, from an extrinsic client device (e.g., a user's smartphone) associated with (e.g., is carried by) the extrinsic client, a request for assistance in facilitation of the potential transaction (e.g., purchasing a CD of a band playing at a rock concert) configured to use the extrinsic client payment channel (e.g., an extrinsic client payment modality of one or more of device authentication via cellular network, indirect device authentication via a device manufacturer network) and the vendor (e.g., a compact disc salesman representative of the band that has set a table up just outside the venue) configured to use the vendor payment channel (e.g., a vendor payment modality of paying via a wireless network).

Referring again to FIG. 8C, operation 818 may include operation 820 depicting receiving, from an extrinsic client device associated with the extrinsic client and having a particular characteristic, a request for assistance in facilitation of the potential transaction between the extrinsic client having the particular characteristic and the vendor configured to use the vendor payment channel that is at least partially different from the extrinsic client payment channel. For example, FIG. 3, e.g., FIG. 3C, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client device that has a particular property and that is associated with the extrinsic client module 320 receiving, from an extrinsic client device (e.g., a laptop that the user is typing on inside of a coffee shop) associated with (e.g., being operated on by the user) the extrinsic client (e.g., a person sitting inside a coffee shop, writing a novel and drinking coffee) and having a particular characteristic (e.g., the laptop has subscribed to the “pay-away” service), a request assist in facilitation of the potential transaction (e.g., placing the order for and paying for the user's coffee drink without getting up to the register) between the extrinsic client (e.g., the laptop device) having the particular characteristic (e.g., the laptop has subscribed to the “pay-away” service and is running the program currently), and the vendor configured to use the vendor payment channel (e.g., a vendor payment option of American Express card and a vendor payment modality of RFID-based credit card tap-and-pay).

Referring again to FIG. 8C, operation 820 may include operation 822 depicting receiving, from an extrinsic client device associated with the extrinsic client and configured to execute a particular application, a request for assistance in facilitation of the potential transaction between the extrinsic client having the particular characteristic and the vendor configured to use the vendor payment channel that is at least partially different from the extrinsic client payment channel. For example, FIG. 3, e.g., FIG. 3C, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a particular application and that is associated with the extrinsic client module 322 receiving, from an extrinsic client device (e.g., a user's smartphone) associated with (e.g., is carried by) the extrinsic client (e.g., a person at a crowded bar) and configured to execute a particular application (e.g., an application that is only available on a particular application store, e.g., an Apple-store exclusive application called “pay my bar tab now”), a request for assistance in facilitation of the potential transaction (e.g., paying the user's bar tab) between the extrinsic client (e.g., the person at the crowded bar carrying the smartphone) and the vendor (e.g., the bar, or the bartender) configured to use the vendor payment channel (e.g., a vendor payment option of cash and traveler's checks and a vendor payment modality of physical examination of the tender) that is at least partially different from the extrinsic client payment channel (e.g., an extrinsic client payment option of “indirect device authentication via an application store service”).

Referring again to FIG. 8C, operation 822 may include operation 824 depicting receiving, from an extrinsic client device associated with the extrinsic client and configured to execute a particular proprietary application, a request for assistance in facilitation of the potential transaction between the extrinsic client having the particular characteristic and the vendor configured to use the vendor payment channel that is at least partially different from the extrinsic client payment channel. For example, FIG. 3, e.g., FIG. 3C, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a proprietary application and that is associated with the extrinsic client module 324 receiving, from an extrinsic client device (e.g., a tablet device, e.g., an Apple iPad) associated with (e.g., the user has a login account on the tablet device) the extrinsic client (e.g., a person waiting in line to buy a new book that is just coming out) and configured to execute a particular proprietary application (e.g., an application that is only on a particular type or brand of devices, e.g., if the device is an Apple iPad, then an application that is only available to other iPads, although in other embodiments the limitation could be more broad, e.g., “all tablet devices,” or “all Apple-branded devices”), a request to assist in facilitation of the potential transaction (e.g., purchasing a new popular book) between the extrinsic client (e.g., the person waiting in line, and the person's tablet device) and the vendor (e.g., the bookstore) configured to use the vendor payment channel (e.g., a vendor payment modality of credit card swipe and signature, and a vendor payment option of credit card alpha, credit card beta, and debit card gamma) that is at least partially different from the extrinsic client payment channel (e.g., an extrinsic client payment option of device authentication via secured wireless network).

Referring now to FIG. 8D, operation 824 may include operation 826 depicting receiving, from an extrinsic client device associated with the extrinsic client and configured to execute a particular proprietary application configured to locate other devices having the particular proprietary application, a request for assistance in facilitation of the potential transaction between the extrinsic client having the particular characteristic and the vendor configured to use the vendor payment channel that is at least partially different from the extrinsic client payment channel. For example, FIG. 3, e.g., FIG. 3C, shows request for assistance in facilitation of a potential transaction between an extrinsic client configured to use an extrinsic client payment channel and a vendor configured to use a vendor payment channel that is at least partially different than the extrinsic client payment channel receiving from an extrinsic client device that is configured to execute a like-finding proprietary application and that is associated with the extrinsic client module 326 receiving, from an extrinsic client device (e.g., a smartphone carried by a user) associated with (e.g., is carried by) the extrinsic client (e.g., the user) and configured to execute a particular proprietary (e.g., the application can only be accessed on a particular device, e.g., through application download control, encryption, or hardware linking/checking, for example) application (e.g., a payment assisting application that is configured to find and receive signals from other “friendly” devices that can assist in carrying out the transaction) configured to locate other devices having the particular proprietary (e.g., the application can only be accessed on a particular device, e.g., through application download control, encryption, or hardware linking/checking, for example) application (e.g., a payment assisting application that is configured to find and receive signals from other “friendly” devices that can assist in carrying out the transaction), a request for assistance in facilitation of the potential transaction (e.g., paying for a magazine at a drugstore where the line is very long, but a “friendly” device that also has the particular proprietary application is near the front of the line, and can communicate with the vendor from its spot in the line and assist in carrying out the potential transaction by relaying and/or converting data received regarding a payment channel) between the extrinsic client (e.g., the user) and the vendor configured to use the vendor payment channel (e.g., device tap using near-field communication as a vendor payment modality) that is at least partially different from the extrinsic client payment channel (e.g., an extrinsic client payment option, e.g., debit card gamma, and an extrinsic client payment modality, e.g., card verification with PIN entry).

Referring now to FIG. 8E, operation 702 may include operation 828 depicting receiving, from an uninvolved entity having a relationship with one or more of the extrinsic client and the vendor, the indication of the potential transaction between the extrinsic client configured to use an extrinsic client payment channel and the vendor configured to use the vendor payment channel that is at least partially different than the extrinsic client payment channel. For example, FIG. 3, e.g., FIG. 3D, shows request for assistance in facilitation of a potential transaction between an extrinsic client configured to use an extrinsic client payment channel and a vendor configured to use a vendor payment channel that is at least partially different than the extrinsic client payment channel receiving from an uninvolved entity module 328 receiving, from an uninvolved entity (e.g., a party, e.g., a person, device, or combination thereof, that is not one of the vendor, extrinsic client, intermediary device, or external coordination device, e.g., as shown in FIG. 2A) having a relationship (e.g., has previously communicated with, stores or collects data on, or is aware of the existence of through communication, either directly or indirectly) with one or more of the extrinsic client and the vendor, the indication of the potential transaction (e.g., paying for electronic items at a big box electronics store) between the extrinsic client (e.g., a customer of the big box store and her smartphone device) configured to use the extrinsic client payment channel (e.g., one extrinsic client payment option, e.g., credit card alpha, and one extrinsic client payment modality, e.g., credit card verification with signature) and the vendor (e.g., the big box electronics store) configured to use the vendor payment channel (e.g., a frequent shopper rewards card as a vendor payment option) that is at least partially different from the extrinsic client payment channel (e.g., one extrinsic client payment option, e.g., credit card alpha, and one extrinsic client payment modality, e.g., credit card verification with signature).

Referring again to FIG. 8E, operation 828 may include operation 830 depicting receiving, from a developer of one or more applications stored in a memory of a device associated with the extrinsic client, the indication of the potential transaction between the extrinsic client and the vendor configured to use the vendor payment channel that is at least partially different than the extrinsic client payment channel. For example, FIG. 3, e.g., FIG. 3D, shows request for assistance in facilitation of a potential transaction between an extrinsic client configured to use an extrinsic client payment channel and a vendor configured to use a vendor payment channel that is at least partially different than the extrinsic client payment channel receiving from an application developer entity module 330 receiving, from a developer (e.g., an entity that designed at least a portion of) of one or more applications (e.g., a program or a piece of a program that is capable of instructing one or more hardware and/or logic gates to carry out an action) stored in a memory of a device (e.g., a smartphone device) associated with (e.g., carried by, owned by, stores data about, retrieves data about, has previously been used by, has previously had data entered into by, was purchased by, and similar) the extrinsic client (e.g., a fan at a baseball game), the indication of the potential transaction (e.g., paying for a scorecard at the baseball game) between the extrinsic client (e.g., the fan at the baseball game) and the vendor (e.g., the scorecard selling guy at the baseball game that is carrying a device that manages payments for him).

Referring again to FIG. 8E, operation 828 may include operation 832 depicting receiving, from a manufacturer of one or more components of a device associated with the extrinsic client, the indication of the potential transaction between the extrinsic client and the vendor configured to use the vendor payment channel that is at least partially different than the extrinsic client payment channel. For example, FIG. 3, e.g., FIG. 3D, shows request for assistance in facilitation of a potential transaction between an extrinsic client configured to use an extrinsic client payment channel and a vendor configured to use a vendor payment channel that is at least partially different than the extrinsic client payment channel receiving from an extrinsic device component developer module 332 receiving, from a manufacturer (e.g., a chip manufacturer for cellular devices and tablet devices, e.g., Samsung components) of one or more components of a device (e.g., whether attached or detachable, hardware, software, firmware, interior or exterior, added at assembly or later in the process) associated with (e.g., carried by, owned by, stores data about, retrieves data about, has previously been used by, has previously had data entered into by, was purchased by, and similar) the extrinsic client (e.g., a movie theater patron), the indication of the potential transaction (e.g., paying for concessions at the movie theater) between the extrinsic client (e.g., the movie theater patron) and the vendor (e.g., the movie theater, or a third party concession seller at the movie theater) configured to use the vendor payment channel (e.g., a vendor payment option of credit card alpha and a vendor payment modality of speech recognition and interaction) that is different than the extrinsic client payment channel.

Referring again to FIG. 8E, operation 702 may include operation 834 depicting receiving, from an intermediary device having a relationship with one or more of the extrinsic client and the vendor, the request for assistance in the facilitation of the potential transaction between the extrinsic client and the vendor. For example, FIG. 3, e.g., FIG. 3D, shows request for assistance in facilitation of a potential transaction between an extrinsic client configured to use an extrinsic client payment channel and a vendor configured to use a vendor payment channel that is at least partially different than the extrinsic client payment channel receiving from an intermediary device module 334 receiving, from an intermediary device (e.g., a device configured to facilitate the transaction between the extrinsic client and the vendor, but is a separate entity from both of the extrinsic client and the vendor, e.g., a smartphone device belonging to another person waiting in line that is not the extrinsic client) having a relationship (e.g., in an example, the intermediary device belongs to the user who is part of the vendor's rewards program) with one or more of the extrinsic client (e.g., a shopper at a grocery store) and the vendor (e.g., the grocery store), the request for assistance in the facilitation of the potential transaction (e.g., paying for dinner) between the extrinsic client configured to use the extrinsic client payment channel (e.g., an extrinsic client payment option, e.g., Gamma Bank branded debit card, and an extrinsic client payment modality, e.g., card verification with PIN entry) and the vendor configured to use the vendor payment channel (e.g., a vendor payment modality of device authentication using wireless network) that is at least partially different from the extrinsic client payment channel (e.g., an extrinsic client payment option, e.g., Gamma Bank branded debit card, and an extrinsic client payment modality, e.g., card verification with PIN entry).

Referring again to FIG. 8E, operation 702 may include operation 836 depicting receiving, from the intermediary device having the relationship with one or more of the extrinsic client and the vendor, an offer to assist in the facilitation the potential transaction between the extrinsic client and the vendor. For example, FIG. 3, e.g., FIG. 3D, shows offer to assist in the facilitation of the potential between the extrinsic client and the vendor receiving from the intermediary device module 336 receiving, from the intermediary device having the relationship with the one or more of the extrinsic client and the vendor, an offer to assist in the facilitation of the potential transaction (e.g., purchasing a digital video disc player at a big-box electronics store) between the extrinsic client (e.g., a purchaser of electronics) and the vendor (e.g., a big-box electronics store)

Referring again to FIG. 8E, operation 834 may include operation 838 depicting receiving, from the intermediary device having a relationship with the extrinsic client, the request for assistance in the facilitation of the potential transaction between the extrinsic client and the vendor. For example, FIG. 3, e.g., FIG. 3D, shows request for assistance in facilitation of a potential transaction between the extrinsic client and the vendor receiving from an intermediary device related to the extrinsic device module 338 receiving, from an intermediary device (e.g., a different user's tablet device) having a relationship with the extrinsic client (e.g., the different user has a same type of tablet device as the extrinsic client), the request for assistance in the facilitation of the potential transaction (e.g., paying for a coffee drink at a coffee shop) between the extrinsic client (e.g., a person sitting at a coffee shop, typing on a tablet) and the vendor (e.g., the coffee shop barista and/or the cash register where the order is taken).

Referring again to FIG. 8E, operation 838 may include operation 840 depicting receiving, from an intermediary device that is configured to communicate through use of a same network as the extrinsic client, the request for assistance in the facilitation of the potential transaction between the extrinsic client and the vendor. For example, FIG. 3, e.g., FIG. 3D, shows request for assistance in facilitation of a potential transaction between the extrinsic client and the vendor receiving from an intermediary device configured to communicate over a same network as the extrinsic device module 340 receiving, from an intermediary device (e.g., a laptop computer in a same classroom as a laptop computer of the extrinsic client) that is configured to communicate through use of a same network (e.g., a school-provided wireless network, or, they both have 4G LTE wireless cards that allow both laptop computers to use the same 4G LTE network) as the extrinsic client (e.g., a student sitting in a classroom with her laptop, who is purchasing items from an online store), the request for assistance in the facilitation of the potential transaction (e.g., the purchasing of items from an online store) between the extrinsic client (e.g., the student sitting in a classroom with her laptop, who is purchasing items from an online store) and the vendor (e.g., the online store).

Referring now to FIG. 8F, operation 702 may include operation 842 depicting receiving, using a proprietary communication channel, a request for assistance in facilitation of the potential transaction between the extrinsic client configured to use the extrinsic client payment channel and the vendor configured to use the vendor payment channel that is at least partially different from the extrinsic client payment channel. For example, FIG. 3, e.g., FIG. 3E, shows request for assistance in facilitation of a potential transaction between an extrinsic client configured to use an extrinsic client payment channel and a vendor configured to use a vendor payment channel that is at least partially different than the extrinsic client payment channel acquiring using a proprietary communication channel module 342 receiving, through a proprietary communication channel (e.g., a form of communication that is shared by proprietary devices, e.g., through a specialized cable, connector, wireless frequency, encryption, or the like), a request for assistance in facilitation of the potential transaction (e.g., paying for electronic items at a big box electronics store) between the extrinsic client (e.g., a customer of the big box store and her smartphone device) configured to use the extrinsic client payment channel (e.g., one extrinsic client payment option, e.g., credit card alpha, and one extrinsic client payment modality, e.g., credit card verification with signature) and the vendor (e.g., the big box electronics store) configured to use the vendor payment channel (e.g., a frequent shopper rewards card as a vendor payment option) that is at least partially different from the extrinsic client payment channel (e.g., one extrinsic client payment option, e.g., credit card alpha, and one extrinsic client payment modality, e.g., credit card verification with signature).

Referring again to FIG. 8F, operation 842 may include operation 844 depicting receiving, using a communication channel available only to one or more devices of a particular type, a request for assistance in facilitation of the potential transaction between the extrinsic client configured to use the extrinsic client payment channel and the vendor configured to use the vendor payment channel that is at least partially different from the extrinsic client payment channel. For example, FIG. 3, e.g., FIG. 3E, shows request for assistance in facilitation of a potential transaction between an extrinsic client configured to use an extrinsic client payment channel and a vendor configured to use a vendor payment channel that is at least partially different than the extrinsic client payment channel acquiring using a communication channel available only to one or more devices having a particular type module 344 receiving, using a communication channel available only to one or more devices of a particular type (e.g., a proprietary encrypted communication broadcasted over a portion of the electromagnetic spectrum that requires a particular chip to encode/decode), a request for assistance in facilitation of the potential transaction (e.g., paying for gasoline at a gas station) between the extrinsic client (e.g., a motor vehicle control system) configured to use the extrinsic client payment channel (e.g., an extrinsic client payment modality of credit card verification with physical card proximity using radio frequency identifiers (“RFID”)) and the vendor (e.g., the gas pump at the gas station) configured to use the vendor payment channel (e.g., credit card with billing zip code entry as a vendor payment modality) that is at least partially different from the extrinsic client payment channel (e.g., an extrinsic client payment modality of credit card verification with physical card proximity using radio frequency identifiers (“RFID”)).

Referring again to FIG. 8F, operation 842 may include operation 846 depicting receiving, through use of a closed-access network, a request for assistance in facilitation of the potential transaction between the extrinsic client configured to use the extrinsic client payment channel and the vendor configured to use the vendor payment channel that is at least partially different from the extrinsic client payment channel. For example, FIG. 3, e.g., FIG. 3F, shows request for assistance in facilitation of a potential transaction between an extrinsic client configured to use an extrinsic client payment channel and a vendor configured to use a vendor payment channel that is at least partially different than the extrinsic client payment channel acquiring using a closed access network module 346 receiving, using a closed-access network (e.g., a wireless network at a fast food restaurant provided to patrons of that restaurant), a request for assistance in facilitation of the potential transaction (e.g., paying for a hamburger and french fries at a fast food restaurant) between the extrinsic client (e.g., the hungry restaurant patron) configured to use the extrinsic client payment channel (e.g., an extrinsic client payment option of online bank account and an extrinsic client payment modality of device biometric identification and authorization release) and the vendor (e.g., the fast food restaurant) configured to use the vendor payment channel (e.g., a vendor payment option of credit card beta and a vendor payment modality of a credit card verification with swipe only) that is at least partially different from the extrinsic client payment channel (e.g., an extrinsic client payment option of online bank account and an extrinsic client payment modality of device biometric identification and authorization release).

FIGS. 9A-9F depict various implementations of operation 704, depicting identifying one or more resources configured to assist in the facilitation of the potential transaction between the extrinsic client and the vendor, said identifying at least partially based on a characteristic of the one or more resources, according to embodiments. Referring now to FIG. 9A, operation 704 may include operation 902 depicting identifying an intermediary device configured to assist in the facilitation of the potential transaction between the extrinsic client and the vendor, said identifying at least partly based on a characteristic of the intermediary device. For example, FIG. 4, e.g., FIG. 4A, shows intermediary device configured to assist in facilitation of the transaction between the extrinsic client and the vendor identifying at least partially based on a characteristic of the one or more resources module 402 identifying (e.g., locating, finding, querying, contacting, selecting, choosing, evaluating, acquiring information about, establishing communication with, verifying, authenticating, recognizing, or otherwise taking one or more steps to use the resource) an intermediary device (e.g., a different cellular telephone device) configured to assist in the facilitation of the potential transaction (e.g., paying a bar tab at a restaurant after the football game is over) between the extrinsic client (e.g., the patron of the restaurant) and the vendor (e.g., the bartender and/or the cash register), said identifying at least partly based on a characteristic of the intermediary device (e.g., the intermediary device is an Apple-branded device, so it is identified).

Referring again to FIG. 9A, operation 902 may include operation 904 depicting identifying a cellular telephone device configured to assist in the facilitation of a transaction of paying for a coffee drink between a purchaser of the coffee drink and a vendor of the coffee drink, said identifying at least partly based on an identified feature of the cellular telephone device that will assist in using the vendor payment channel to facilitate receipt of payment for the coffee drink. For example, FIG. 4, e.g., FIG. 4A, shows cellular telephone device with identified feature configured to assist in facilitation of the transaction between the extrinsic client and the vendor identifying at least partially based on a characteristic of the one or more resources module 404 identifying a cellular telephone device configured to assist in the facilitation of a transaction of paying for a coffee drink between a purchaser of the coffee drink and a vendor of the coffee drink, said identifying at least partly based on an identified feature of the cellular telephone device that will assist in using the vendor payment channel to facilitate receipt of payment for the coffee drink.

Referring again to FIG. 9A, operation 904 may include operation 906 depicting identifying an intermediary device configured to assist in the facilitation of the potential transaction between the extrinsic client and the vendor, said identifying at least partly based on a proximity of the intermediary device to the extrinsic client. For example, FIG. 4, e.g., FIG. 4A, shows intermediary device configured to assist in facilitation of the transaction between the extrinsic client and the vendor identifying at least partially based on a proximity of the intermediary device to one or more of the extrinsic client and the vendor module 406 identifying (e.g., selecting) an intermediary device (e.g., a different user's smartphone device) configured to assist in the facilitation of the potential transaction (e.g., buying popcorn and cracker jacks at a baseball game) between the extrinsic client (e.g., the fan at the game) and the vendor (e.g., the concession stand), at least partly based on a proximity of the intermediary device to the extrinsic client (e.g., the intermediary device is in the same line waiting to buy peanuts, and thus is selected due to proximity, in case one of the payment modalities requires limited-range transmission).

Referring again to FIG. 9A, operation 904 may include operation 908 depicting identifying an intermediary device configured to assist in the facilitation of the potential transaction between the extrinsic client and the vendor, said identifying at least partly based on a proximity of the intermediary device to the vendor. For example, FIG. 4, e.g., FIG. 4A, shows intermediary device configured to assist in facilitation of the transaction between the extrinsic client and the vendor identifying at least partially based on a proximity of the intermediary device to the vendor module 408 identifying an intermediary device (e.g., an uninvolved person's smartphone device) configured to assist in the facilitation of the potential transaction (e.g., purchasing a chimichanga from a Mexican food truck) between the extrinsic client (e.g., the person who is at the front of the line at the food truck) and the vendor (e.g., the food truck), said identifying at least partly based on a proximity of the intermediary device (e.g., the uninvolved person is waiting in line for a different food truck, e.g., the cheese steak truck, but is close to the Mexican food truck) to the vendor (e.g., the Mexican food truck).

Referring again to FIG. 9A, operation 904 may include operation 910 depicting identifying an intermediary device configured to assist in the facilitation of the potential transaction between the extrinsic client and the vendor, said identifying at least partly based on a feature present on the intermediary device. For example, FIG. 4, e.g., FIG. 4A, shows intermediary device configured to assist in facilitation of the transaction between the extrinsic client and the vendor identifying at least partially based on a capability of the intermediary device module 410 identifying an intermediary device (e.g., a motor vehicle control system of a Toyota-branded motor vehicle) configured to assist in the facilitation of the potential transaction (e.g., paying for a coke, a bag of chips, and an unevenly-warmed microwaveable burrito at a gas station) between the extrinsic client (e.g., a person and his cell phone standing in line at the gas station) and the vendor (e.g., the gas station attendant), said identifying at least partly based on a feature present on the intermediary device (e.g., the motor vehicle control system of the Toyota includes Bluetooth network capacity).

Referring again to FIG. 9A, operation 910 may include operation 912 depicting identifying an intermediary device configured to assist in the facilitation of the potential transaction between the extrinsic client and the vendor, said identifying at least partly based on a capacity to use one or more of the vendor payment channel and the extrinsic client payment channel. For example, FIG. 4, e.g., FIG. 4A, shows intermediary device configured to assist in facilitation of the transaction between the extrinsic client and the vendor identifying at least partially based on an ability to process at least a portion of one or more of the vendor payment channel and the extrinsic client payment channel module 412 identifying an intermediary device (e.g., a motor vehicle control system of a Ford truck) configured to assist in the facilitation of the potential transaction (e.g., paying for gas at the pump) between the extrinsic client (e.g., a motor vehicle control system of a Honda-branded sedan) and the vendor (e.g., the gas station/gas pump), said identifying at least partly based on a capacity to use one or more of the vendor payment channel (e.g., a vendor payment option of cash and traveler's checks and a vendor payment modality of physical examination of the tender) and the extrinsic client payment channel (e.g., an extrinsic client payment option of device authentication via secured wireless network).

Referring again to FIG. 9A, operation 912 may include operation 914 depicting identifying an intermediary device configured to assist in the facilitation of the potential transaction between the extrinsic client and the vendor, said identifying at least partly based on a capacity to use both of the vendor payment channel and the extrinsic client payment channel. For example, FIG. 4, e.g., FIG. 4A, shows intermediary device configured to assist in facilitation of the transaction between the extrinsic client and the vendor identifying at least partially based on an ability to process the vendor payment channel and the extrinsic client payment channel module 414 identifying an intermediary device (e.g., an unrelated person's smartphone device) configured to assist in the facilitation of the potential transaction (e.g., paying for items at a fast food window) between the extrinsic client (e.g., a person sitting in her car equipped with a motor vehicle control system that can submit payment using an extrinsic client payment channel) and the vendor (e.g., the fast food restaurant), said identifying at least partly based on a capacity to use both of the vendor payment channel (e.g., a vendor payment modality of credit card swipe and signature, and a vendor payment option of credit card alpha, credit card beta, and debit card gamma) and the extrinsic client payment channel (e.g., an extrinsic client payment option, e.g., debit card gamma, and an extrinsic client payment modality, e.g., card verification with PIN entry).

Referring now to FIG. 9B, operation 902 may include operation 916 depicting identifying an intermediary device configured to assist in the facilitation of the potential transaction between the extrinsic client and the vendor, said identifying at least partly based on an intermediary device type. For example, FIG. 4, e.g., FIG. 4B, shows intermediary device configured to assist in facilitation of the transaction between the extrinsic client and the vendor identifying at least partially based on an intermediary device type module 416 identifying an intermediary device (e.g., a tablet device of user seated five rows away at a hockey game) configured to assist in the facilitation of the potential transaction (e.g., purchasing an embroidered hockey sweater) between the extrinsic client (e.g., the purchaser of the sweater) and the vendor (e.g., the team shop at the arena), said identifying at least partly based on an intermediary device type (e.g., the tablet device of the user sitting five rows away is selected because it has an antenna manufactured by a particular company).

Referring again to FIG. 9B, operation 916 may include operation 918 depicting identifying an intermediary device configured to assist in the facilitation of the potential transaction between the extrinsic client and the vendor, said identifying at least partly based on a manufacturer of the intermediary device. For example, FIG. 4, e.g., FIG. 4B, shows intermediary device configured to assist in facilitation of the transaction between the extrinsic client and the vendor identifying at least partially based on a device manufacturer identity module 418 identifying an intermediary device (e.g., a cellular telephone device of the person two seats down from the extrinsic client at a movie theater) configured to assist in the facilitation of the potential transaction (e.g., paying for tickets to a movie after arrival in the theater) between the extrinsic client (e.g., the moviegoer) and the vendor (e.g., the theater operator and her hand-held ticket scanner), said identifying at least partly based on a manufacturer of the intermediary device (e.g., the cellular telephone device of the person two seats down from the extrinsic client at a movie theater is a Nokia-branded device).

Referring again to FIG. 9B, operation 902 may include operation 920 depicting identifying an intermediary device configured to assist in the facilitation of the potential transaction between the extrinsic client and the vendor, said identifying at least partly based on one or more applications present on a memory of the intermediary device. For example, FIG. 4, e.g., FIG. 4B, shows intermediary device configured to assist in facilitation of the transaction between the extrinsic client and the vendor identifying at least partially based on one or more applications resident in a memory of the intermediary device module 420 identifying an intermediary device (e.g., a laptop computer of a person in the same train car as an extrinsic client) configured to assist in the facilitation of the potential transaction (e.g., purchasing train tickets on the train) between the extrinsic client (e.g., the train passenger) and the vendor (e.g., the train company), said identifying at least partly based on one or more applications (e.g., there may be an application that is directed to facilitating transactions, or it may be an unrelated application, e.g., a word processing application, or an online game) present on a memory of the intermediary device (e.g., the laptop computer of a person in the same train car as an extrinsic client).

Referring now to FIG. 9C, operation 704 may include operation 922 depicting obtaining a list of one or more resources configured to assist in the facilitation of the potential transaction between the extrinsic client and the vendor. For example, FIG. 4, e.g., FIG. 4C shows list of one or more resources configured to assist in the facilitation of the potential transaction between the extrinsic client and the vendor acquiring module 422 obtaining a list of one or more resources (e.g., one or more devices that meet one or more criteria) configured to assist in the facilitation of the potential transaction (e.g., paying for team jerseys at a sporting goods store) between the extrinsic client (e.g., the shopper) and the vendor (e.g., the sporting goods store).

Referring again to FIG. 9C, operation 704 may include operation 924 depicting identifying a particular resource from the one or more resources at least partly based on a characteristic of the particular resource. For example, FIG. 4, e.g., FIG. 4C, shows particular resource from the acquired list of one or more resources selecting at least partly based on a particular resource characteristic module 424 identifying a particular resource (e.g., a particular user's smartphone device) from the one or more resources (e.g., all of the smartphone devices detected in aisle seven of the sporting goods store), at least partly based on a characteristic of the particular resource (e.g., the particular user's smartphone device has a wireless antenna configured to communicate using the 802.11 ac standard).

Referring again to FIG. 9C, operation 922 may include operation 926 depicting obtaining a list of one or more resources that have a characteristic in common, said one or more resources configured to assist in the facilitation of the potential transaction between the extrinsic client and the vendor. For example, FIG. 4, e.g., FIG. 4C, shows list of one or more resources having a common property and that are configured to assist in the facilitation of the potential transaction between the extrinsic client and the vendor acquiring module 426 obtaining a list of one or more resources (e.g. one or more devices) that have a characteristic in common (e.g., all can communicate via Bluetooth, are all tablet devices, are all Apple-branded devices, all have a particular application running on them, are all at a particular location, have all signed a particular service agreement for cellular network service, or have all signed a particular service agreement for assistance in facilitation of transactions), said one or more resources configured to assist in the facilitation of the potential transaction (e.g., buying a pretzel at the airport) between the extrinsic client (e.g., the pretzel buyer) and the vendor (e.g., the pretzel vendor).

Referring again to FIG. 9C, operation 926 may include operation 928 depicting obtaining a list of one or more resources that are manufactured by a common manufacturer, said one or more resources configured to assist in the facilitation of the potential transaction between the extrinsic client and the vendor. For example, FIG. 4, e.g., FIG. 4C, shows list of one or more resources that are one or more devices having a common manufacturer and that are configured to assist in the facilitation of the potential transaction between the extrinsic client and the vendor acquiring module 428 obtaining a list of one or more resources (e.g., tablet devices and smartphone devices, for example) that are manufactured by a common manufacturer (e.g., either in whole, e.g., an end manufacturer, or in part, e.g., a chip manufacturer), said one or more resources configured to assist in the facilitation of the potential transaction (e.g., paying for electronic items at a big box electronics store) between the extrinsic client and the vendor.

Referring again to FIG. 9C, operation 926 may include operation 930 depicting obtaining a list of one or more resources that are using a same operating system, said one or more resources configured to assist in the facilitation of the potential transaction between the extrinsic client and the vendor. For example, FIG. 4, e.g., FIG. 4C, shows list of one or more resources that are one or more devices having a common operating system and that are configured to assist in the facilitation of the potential transaction between the extrinsic client and the vendor acquiring module 430 obtaining a list of one or more resources (e.g., wearable computing glasses) that are using a same operating system (e.g., Android-based operating system), said one or more resources configured to assist in the facilitation of the potential transaction e.g., paying for a hamburger and french fries at a fast food restaurant) between the extrinsic client (e.g., the purchaser of fast food) and the vendor (e.g., the restaurant).

Referring again to FIG. 9C, operation 926 may include operation 932 depicting obtaining a list of one or more resources that are configured to communicate on a same communication network, said one or more resources configured to assist in the facilitation of the potential transaction between the extrinsic client and the vendor. For example, FIG. 4, e.g., FIG. 4C, shows list of one or more resources that are one or more devices that are connected to a same communication network and that are configured to assist in the facilitation of the potential transaction between the extrinsic client and the vendor acquiring module 432 obtaining a list of one or more resources (e.g., smartphone devices) that are configured to communicate on a same communication network (e.g., over Verizon's 4G LTE network, or AT&T's EDGE network), said one or more resources configured to assist in the facilitation of the potential transaction (e.g., buying a giant foam finger at a basketball game) between the extrinsic client and the vendor.

Referring now to FIG. 9D, operation 922 may include operation 934 depicting monitoring one or more known devices to obtain a list of one or more devices configured to assist in the facilitation of the potential transaction between the extrinsic client and the vendor. For example, FIG. 4, e.g., FIG. 4C, shows list of one or more resources configured to assist in the facilitation of the potential transaction between the extrinsic client and the vendor generating through a monitor of one or more known devices module 434 monitoring one or more known devices (e.g., devices for which enough data is known about the devices to monitor them) to obtain a list of one or more devices configured to assist in the facilitation of the potential transaction (e.g., buying digitally encoded Matt & Kim musical concert performances) between the extrinsic client (e.g., the music purchaser) and the vendor (e.g., the music seller, whether retail or online).

Referring again to FIG. 9D, operation 934 may include operation 936 depicting polling one or more devices that have previously accessed a marketplace, to obtain a list of one or more devices configured to assist in the facilitation of the potential transaction between the extrinsic client and the vendor. For example, FIG. 4, e.g., FIG. 4C, shows list of one or more resources configured to assist in the facilitation of the potential transaction between the extrinsic client and the vendor generating through a poll of marketplace-accessed devices module 436 polling one or more devices (e.g., one or more tablet devices) that have previously accessed a marketplace (e.g., an online store where the tablet user can login to her account and purchase games, movies, music, books, or other consumable media), to obtain a list of one or more devices configured to assist in the facilitation of the potential transaction (e.g., buying a pair of men's dress shoes from a shoe store) between the extrinsic client and the vendor).

Referring again to FIG. 9D, operation 934 may include operation 938 depicting monitoring one or more devices that have installed a particular application, to obtain a list of one or more devices configured to assist in the facilitation of the potential transaction between the extrinsic client and the vendor. For example, FIG. 4, e.g., FIG. 4C, shows list of one or more resources configured to assist in the facilitation of the potential transaction between the extrinsic client and the vendor generating through a poll of one or more application-installed devices module 438 monitoring one or more of the devices that have installed a particular application (e.g., an application that allows both the use of intermediary devices to facilitate transactions, and also allows the device to act as an intermediary device in connection with an external coordination device), to obtain a list of one or more devices configured to assist in the facilitation of the potential transaction (e.g., purchasing movie theater popcorn after being seated at the movie theater) between the extrinsic client (e.g., the moviegoer) and the vendor (e.g., the movie theater).

FIGS. 10A-10D depict various implementations of operation 706 depicting providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction, according to embodiments. Referring now to FIG. 10A, operation 706 may include operation 1002 depicting providing location data related to one or more of the extrinsic client configured to use the extrinsic client payment channel and the vendor configured to use the vendor payment channel, to the identified one or more resources, said location data configured to be used by the one or more resources to facilitate the potential transaction. For example, FIG. 5, e.g., FIG. 5A, shows location data related to one or more of the extrinsic client and the vendor and configured to be used by the identified one or more resources providing to the identified one or more resources module 502 providing location data related to one or more of the extrinsic client (e.g., a user buying the coffee drink) configured to use the extrinsic client payment channel (e.g., a client payment modality of credit card verification with swipe only) and the vendor configured to use the vendor payment channel (e.g., a vendor payment modality of payment modality of credit card verification with billing zip code), to the identified one or more resources (e.g., a device configured to facilitate the transmission), said location data configured to be used the one or more resources to facilitate the potential transaction.

Referring again to FIG. 10A, operation 1002 may include operation 1004 depicting providing location data of an extrinsic client device associated with the extrinsic client and configured to use the extrinsic client payment channel, to the identified one or more resources, said location data configured to be used by the one or more resources to contact the extrinsic client device to facilitate the potential transaction. For example, FIG. 5, e.g., FIG. 5A, shows location data of an extrinsic client device related to the extrinsic client and configured to be used by the identified one or more resources providing to the identified one or more resources module 504 providing location data of an extrinsic client device (e.g., a laptop that the user is typing on inside of a coffee shop) associated with (e.g., being operated on by the user) the extrinsic client (e.g., a person sitting inside a coffee shop, writing a novel and drinking coffee) and configured to use the extrinsic client payment channel (e.g., an extrinsic client payment option, e.g., Gamma Bank branded debit card, and an extrinsic client payment modality, e.g., card verification with PIN entry), to the identified one or more resources (e.g., a person sitting at a different table in the coffee shop, sending text messages on her cellular smartphone), said location data configured to be used by the one or more resources to contact the extrinsic client device to facilitate the potential transaction (e.g., placing the order for and paying for the user's coffee drink without getting up to the register).

Referring again to FIG. 10A, operation 1004 may include operation 1006 depicting providing an internet protocol address of an extrinsic client device associated with the extrinsic client and configured to use the extrinsic client payment channel including an extrinsic client payment modality of a bank account that debits through vehicle device automation and an extrinsic client payment option of bank account type kappa, to an identified intermediary device, said internet protocol address configured to be used by the intermediary device to contact the extrinsic client device to facilitate the potential transaction. For example, FIG. 5, e.g., FIG. 5A, shows internet protocol address data of an extrinsic client device related to the extrinsic client and configured to be used by the identified one or more resources providing to the identified one or more resources module 506 providing an internet protocol address of an extrinsic client device associated with the extrinsic client and configured to use the extrinsic client payment channel including an extrinsic client payment modality of a bank account that debits through vehicle device automation and an extrinsic client payment option of bank account type kappa, to an identified intermediary device, said internet protocol address configured to be used by the intermediary device to contact the extrinsic client device to facilitate the potential transaction

Referring again to FIG. 10A, operation 706 may include operation 1008 depicting providing transaction data related to an extrinsic client device associated with the extrinsic client and configured to use the extrinsic payment channel, to the identified one or more resources, said potential transaction data configured to be used by the one or more resources to facilitate the potential transaction. For example, FIG. 5, e.g., FIG. 5A, shows transaction data related to an extrinsic client device associated with the extrinsic client configured to be used by the identified one or more resources providing to the identified one or more resources module 508 providing transaction data (e.g., a password to an online banking account associated with the extrinsic client) related to an extrinsic client device (e.g., a user's smartphone) associated with (e.g., is carried by) the extrinsic client (e.g., a person waiting in a long line at a drugstore) and configured to use the extrinsic client payment channel (e.g., one extrinsic client payment option, e.g., credit card alpha, and one extrinsic client payment modality, e.g., credit card verification with signature), to the identified one or more resources (e.g., another device that is located closer to the front of the line and that is configured to communicate with the vendor from its spot in the line and assist in carrying out the potential transaction by relaying and/or converting data received regarding a payment channel), said potential transaction data (e.g., a password to an online banking account) configured to be used by the one or more resources to facilitate the potential transaction (e.g., paying for a magazine at a drugstore where the line is very long).

Referring now to FIG. 10B, operation 706 may include operation 1010 depicting providing transaction data related to the vendor, to the identified one or more resources, said potential transaction data configured to be used by the one or more resources to facilitate the potential transaction. For example, FIG. 5, e.g., FIG. 5B, shows transaction data related to the vendor and configured to be used by the identified one or more resources providing to the identified one or more resources module 510 providing transaction data related to the vendor (e.g., an ordered list of the vendor's preferences for payment channels, or a list of the alternate payment channels supported by the vendor, and a rank of how secure each of the alternate payment channels is, based on the vendor analysis), to the identified one or more resources (e.g., a device that is not the extrinsic client or the vendor), said potential transaction data configured to be used by the one or more resources to facilitate the potential transaction (e.g., purchasing a coffee at a coffee shop).

Referring again to FIG. 10B, operation 1010 may include operation 1012 depicting providing data regarding an amount of compensation offered by the vendor in exchange for assistance in facilitation of the potential transaction to the identified one or more resources, said potential transaction data configured to be used by the one or more resources to facilitate the potential transaction. For example, FIG. 5, e.g., FIG. 5B, shows transaction data related to the vendor including an amount of vendor-offered compensation for facilitation service and configured to be used by the identified one or more resources providing to the identified one or more resources module 512 providing data regarding an amount of compensation offered by the vendor in exchange for assistance in facilitation of the potential transaction to the identified one or more resources (e.g., one or more devices that are not owned or carried by the extrinsic client or the vendor), said potential transaction data configured to be used by the one or more resources to facilitate the potential transaction (e.g., to assist in determining whether to facilitate the potential transaction or to pass the transaction off to a different resource that may be willing to assist in the facilitation).

Referring again to FIG. 10B, operation 708 may include operation 1014 depicting providing data regarding a property of the potential transaction between the extrinsic client and the vendor, to the identified one or more resources, said data regarding the property of the potential transaction configured to be used by the one or more resources to determine whether to agree to assist in facilitation of the potential transaction. For example, FIG. 5, e.g., FIG. 5B, shows transaction data regarding a property of the potential transaction and configured to be used by the identified one or more resources providing to the identified one or more resources module 514 providing data regarding a property of the potential transaction (e.g., the amount of processing power that is estimated to be needed to carry out the potential transaction) between the extrinsic client (e.g., a shopper buying groceries and toiletries) and the vendor (e.g., a grocery store where the shopper is buying groceries and toiletries), to the identified one or more resources, said data regarding the property of the potential transaction configured to be used by the one or more resources to determine whether to agree to assist in facilitation of the potential transaction.

Referring again to FIG. 10B, operation 1014 may include operation 1016 depicting providing data regarding a value of the potential transaction between the extrinsic client and the vendor, to the identified one or more resources, said data regarding the value of the potential transaction configured to be used by the one or more resources to determine whether to agree to assist in facilitation of the potential transaction. For example, FIG. 5, e.g., FIG. 5B, shows transaction data regarding a value of the potential transaction and configured to be used by the identified one or more resources providing to the identified one or more resources module 516 providing data regarding a value of the potential transaction between the extrinsic client (e.g., a fan at the team shop of a football stadium) and the vendor (e.g., a fan shop inside an NFL stadium), to the identified one or more resources, said data regarding the value of the potential transaction (e.g., the monetary value, e.g., if the extrinsic client is purchasing an authentic NFL jersey from a team shop at the stadium, then the monetary value may be, e.g., 300 dollars) configured to be used by the one or more resources to determine whether to agree to assist in facilitation of the potential transaction.

Referring now to FIG. 10C, operation 706 may include operation 1018 depicting providing one or more instructions for assistance in facilitation of the potential transaction between the extrinsic client and the vendor to the identified one or more resources, said instructions for assistance in facilitation of the potential transaction configured to be used by the one or more resources. For example, FIG. 5, e.g., FIG. 5C, shows instruction for assistance in use of the extrinsic payment channel with the vendor payment channel providing to the identified one or more resources module 518 providing one or more instructions (e.g., how to find a bank associated with the extrinsic client payment option) for assistance in facilitation of the potential transaction (e.g., paying for books at a book store) between the extrinsic client and the vendor to the identified one or more resources (e.g., a laptop device of a person sitting at a table in the back of the bookstore eating a bagel and reading), said instructions (e.g., how to find a bank associated with the extrinsic client payment option) for assistance in facilitation of the potential transaction (e.g., paying for books at a book store configured to be used by the one or more resources (e.g., a laptop device of a person sitting at a table in the back of the bookstore eating a bagel and reading).

Referring again to FIG. 10C, operation 1018 may include operation 1020 depicting providing one or more instructions for adapting the extrinsic client payment channel for use with the vendor payment channel to assist in facilitation of the potential transaction between the extrinsic client and the vendor, to the identified one or more resources. For example, FIG. 5, e.g., FIG. 5C, shows instruction for adapting the extrinsic payment channel for use with the vendor payment channel providing to the identified one or more resources module 520 providing one or more instructions (e.g., how to decode the data stream used by the vendor payment modality) for adapting the extrinsic client payment channel (e.g., an extrinsic client payment modality of one or more of device authentication via cellular network, indirect device authentication via a device manufacturer network) for use with the vendor payment channel (e.g., a vendor payment modality of paying via a wireless network) to assist in facilitation of the potential transaction (e.g., purchasing a suit and tie at a men's clothing store) between the extrinsic client and the vendor, to the identified one or more resources (e.g., a device configured to facilitate the transaction between the extrinsic client and the vendor).

Referring again to FIG. 10C, operation 1018 may include operation 1022 depicting providing one or more instructions for converting the extrinsic client payment channel for use with the vendor payment channel to assist in facilitation of the potential transaction between the extrinsic client and the vendor, to the identified one or more resources. For example, FIG. 5, e.g., FIG. 5C, shows instruction for converting data regarding the extrinsic payment channel into data for use with the vendor payment channel providing to the identified one or more resources module 522 providing one or more instructions for converting the extrinsic client payment channel (e.g., an extrinsic client payment option, e.g., credit card beta, and/or an extrinsic client payment modality (e.g., a credit card verification with signature)) for use with the vendor payment channel (e.g., a vendor payment option a debit card from bank alpha and a vendor payment modality of a debit card with PIN entry) to assist in facilitation of the potential transaction (e.g., purchasing a gravlax from a Swedish food truck) between the extrinsic client and the vendor, to the identified one or more resources (e.g., a device that is also in line for gravlax).

Referring again to FIG. 10C, operation 1018 may include operation 1024 depicting providing one or more instructions for a collection of payment from the extrinsic client through use of the extrinsic client payment channel. For example, FIG. 5, e.g., FIG. 5C, shows instruction for a collection of payment from the extrinsic client through use of the extrinsic client payment channel providing module 524 providing one or more instructions for a collection of payment (e.g., a bank account and routing number, and an authorization code) from the extrinsic client through use of the extrinsic client payment channel (e.g., electronic funds transfer via wireless network with code authentication).

Referring again to FIG. 10C, operation 1018 may include operation 1026 depicting providing one or more instructions for a dispersal of payment to the vendor through use of the vendor payment channel. For example, FIG. 5, e.g., FIG. 5C, shows instruction for a dispersal of the payment to the vendor through use of the vendor payment channel providing module 526 providing one or more instructions (e.g., a number of “Points” in an online marketplace, e.g., the Xbox games marketplace to be deposited with a particular username that corresponds to the vendor, who has requested to be paid in Xbox points) through use of the vendor payment channel (e.g., online points).

Referring again to FIG. 10C, operation 1018 may include operation 1028 depicting providing one or more instructions for use of data gathered in the collection of payment from the extrinsic client through use of the extrinsic client payment channel, in the dispersal of payment to the vendor through use of the vendor payment channel. For example, FIG. 5, e.g., FIG. 5C, shows instruction for application of the data gathered in the collection of payment from the extrinsic client through use of the extrinsic client payment channel to the dispersal of payment to the vendor through use of the vendor payment channel providing module 528 providing one or more instructions for use of data gathered (e.g., an image file of the extrinsic client's signature retrieved from a canceled check while accessing the extrinsic client's bank account to use bank gamma as an extrinsic client payment option) in the collection of payment from the extrinsic client through use of the extrinsic client payment channel (e.g., an extrinsic client payment option of electronic debiting from an account with bank delta), in the dispersal of payment to the vendor (e.g., an account authorization using authentication through electronic signature verification as the vendor payment channel).

Referring now to FIG. 10D, operation 706 may include operation 1030 depicting providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction. For example, FIG. 5, e.g., FIG. 5D, shows transaction data related to one or more of the extrinsic client and the vendor and configured to be used by an intermediary device providing to the intermediary device module 530 providing potential transaction data (e.g., data regarding how much money the transaction is worth) related to one or more of the extrinsic client (e.g., the hungry restaurant patron) configured to use the extrinsic client payment channel (e.g., an extrinsic client payment option of online bank account and an extrinsic client payment modality of device biometric identification and authorization release) and the vendor (e.g., the fast food restaurant) configured to use the vendor payment channel (e.g., a vendor payment option of credit card beta and a vendor payment modality of a credit card verification with swipe only), to an intermediary device (e.g., a smartphone device of a person at a different table), said potential transaction data (e.g., data regarding how much money the transaction is worth) configured to be used by the intermediary device to facilitate the potential transaction (e.g., paying for a steak and garlic fries at a high-end restaurant).

Referring again to FIG. 10D, operation 1030 may include operation 1032 depicting providing potential transaction data that includes an authorization for the intermediary device to access an account associated with the extrinsic client, to an intermediary device having a particular property, said potential transaction data configured to be used by the intermediary device to facilitate the potential transaction. For example, FIG. 5, e.g., FIG. 5D, shows transaction data related to one or more of the extrinsic client and the vendor and configured to be used by an intermediary device having a particular property providing to the intermediary device module 532 providing potential transaction data that includes an authorization for the intermediary device (e.g., a smartphone of a user that is not the extrinsic client or the vendor) to access an account (e.g., a line of credit provided by a credit card company) associated with the extrinsic client (e.g., a concert attendee who wishes to purchase a compact disc of the band she is watching), to an intermediary device having a particular property (e.g., an intermediary device that has a trusted relationship with the provider of the account associated with the extrinsic client, e.g., the intermediary device also has an account with the provider), said potential transaction data configured to be used by the intermediary device to facilitate the potential transaction (e.g., the purchase of a compact disc at a music concert).

Referring again to FIG. 10D, operation 1030 may include operation 1034 depicting providing potential transaction data that includes an instruction for converting a product code acquired by the extrinsic client into a vendor-specific code that is configured to be used by the vendor to determine a cost of the product, to an intermediary device having a particular property in common with an extrinsic client device carried by the extrinsic client, said potential transaction data configured to be used by the intermediary device to facilitate the potential transaction. For example, FIG. 5, e.g., FIG. 5D, shows transaction data related to one or more of the extrinsic client and the vendor and configured to be used by an intermediary device having a particular property in common with an extrinsic client device associated with the extrinsic client providing to the intermediary device module 534 providing potential transaction data that includes an instruction for converting a providing potential transaction data that includes an instruction for converting a product code (e.g., a code for one or more food items in the user's cart, e.g., a universal product code (“UPC”)) acquired by the extrinsic client (e.g., a grocery shopper) into a vendor-specific code that is configured to be used by the vendor to determine a cost of the product, to an intermediary device (e.g., a wearable device worn by a different shopper in the grocery store) having a particular property in common (e.g., they both run the Android operating system) with an extrinsic client device (e.g., the extrinsic client's book e-reader) carried by the extrinsic client, said potential transaction data configured to be used by the intermediary device to facilitate the potential transaction (e.g., paying for groceries at the grocery store).

Referring again to FIG. 10D, operation 1030 may include operation 1036 depicting providing potential transaction data that includes an instruction for adapting the extrinsic client payment channel for use with the vendor payment channel, to an intermediary device that is configured to execute a same particular proprietary application as the extrinsic client device carried by the extrinsic client, said potential transaction data configured to be used by the intermediary device to facilitate the potential transaction. For example, FIG. 5, e.g., FIG. 5D, shows transaction data related to one or more of the extrinsic client and the vendor and configured to be used by an intermediary device having a particular proprietary application resident in memory that is also present on an extrinsic client device associated with the extrinsic client providing to the intermediary device module 536 providing potential transaction data that includes an instruction for adapting the extrinsic client payment channel (e.g., credit card verification with billing zip code) for use with the vendor payment channel (a new form of device communication called “Green Lightning” (e.g., this is hypothetical, no such protocol exists at the time of filing, and any similarity between this hypothetical protocol and a real protocol is strictly coincidental) that a particular vendor is distributing to various devices in order to try to get the device protocol more widely adopted), to an intermediary device that is configured to execute a same particular proprietary application (e.g., the “Green Lightning” application) as the extrinsic client device carried by the extrinsic client, said potential transaction data configured to be used by the intermediary device to facilitate the potential transaction (e.g., the “Green Lightning” protocol on the intermediary device and the client device allows the client device to use its credit card securely through the Green Lightning transfer protocol.

Referring again to FIG. 10D, operation 1030 may include operation 1034 may include operation 1038 depicting providing potential transaction data related to one or more of the extrinsic client configured to use the extrinsic client payment channel and the vendor configured to use the vendor payment channel, to an intermediary device having a similar configuration as the extrinsic client device carried by the extrinsic client, said potential transaction data configured to be used by the intermediary device to facilitate the potential transaction. For example, FIG. 5, e.g., FIG. 5D, shows transaction data related to one or more of the extrinsic client and the vendor and configured to be used by an intermediary device having a similar configuration as an extrinsic client device associated with the extrinsic client providing to the intermediary device module 538 providing potential transaction data (e.g., a conversion rate for changing from a first payment option (e.g., bank debit card) to a second payment option (e.g., store credit card) related to one or more of the extrinsic client (e.g., a patron of a book store and their tablet device) configured to use an extrinsic client payment channel (e.g., an extrinsic client payment option, e.g., credit card beta, and/or an extrinsic client payment modality (e.g., a credit card verification with signature)) and a vendor (e.g., the bookstore owner and her cash register) configured to use a vendor payment channel (e.g., a vendor payment option a debit card from bank alpha and a vendor payment modality of a debit card with PIN entry), to an intermediary device having a similar configuration as the extrinsic client device carried by the extrinsic client, said potential transaction data configured to be used by the intermediary to facilitate the potential transaction.

Referring now to FIG. 10E, operation 1030 may include operation 1040 depicting providing potential transaction data related to one or more of the extrinsic client configured to use the extrinsic client payment channel and the vendor configured to use the vendor payment channel, to an intermediary device that is anonymous to one or more of the extrinsic client and the vendor, said potential transaction data configured to be used by the intermediary device to facilitate the potential transaction. For example, FIG. 5, e.g., FIG. 5E, shows transaction data related to one or more of the extrinsic client and the vendor and configured to be used by the intermediary device providing to the intermediary device that is anonymous to one or more of the extrinsic client and the vendor module 540 providing potential transaction data related to one or more of extrinsic client (e.g., a user with the extrinsic client device, e.g., the smartphone) configured to use an extrinsic client payment channel (e.g., an extrinsic client payment option, e.g., PayPal. and/or an extrinsic client payment modality (e.g., device tap) and the vendor (e.g., the bar or bartender and his device) configured to use a vendor payment channel (e.g., two vendor payment options, e.g., corporate credit card, and PayPal, and two vendor payment modalities, e.g., credit card verification with physical card proximity using radio frequency identifiers (“RFID”), and device tap using near field communication (“NFC”)), to an intermediary device that is anonymous (e.g., based on the potential transaction, one or more of the vendor and the extrinsic client cannot derive a unique identity of the intermediary device) to one or more of the extrinsic client (e.g., a user with the client device, e.g., the smartphone) and the vendor (e.g., the bar or bartender and his device), said potential transaction data configured to be used by the intermediary device to facilitate the potential transaction (e.g., paying a bar tab at a crowded bar).

Referring again to FIG. 10E, operation 1030 may include operation 1042 depicting providing potential transaction data related to one or more of the extrinsic client configured to use the extrinsic client payment channel and the vendor configured to use the vendor payment channel, to an intermediary device that has an identity that is hidden from one or more of the extrinsic client and the vendor, said potential transaction data configured to be used by the intermediary device to facilitate the potential transaction. For example, FIG. 5, e.g., FIG. 5E, shows transaction data related to one or more of the extrinsic client and the vendor and configured to be used by the intermediary device providing to the intermediary device for which the identity is hidden from one or more of the extrinsic client and the vendor module 542 providing potential transaction data related to one or more of the extrinsic client (e.g., a motor vehicle control system) configured to use the extrinsic client payment channel (e.g., an extrinsic client payment modality of credit card verification with physical card proximity using radio frequency identifiers (“RFID”)) and the vendor (e.g., the gas pump at the gas station) configured to use the vendor payment channel (e.g., credit card with billing zip code entry as a vendor payment modality), to an intermediary device (e.g., a motor vehicle control system of a different car) that has an identity that is hidden from one or more of the extrinsic client and the vendor, said potential transaction data configured to be used by the intermediary device to facilitate the potential transaction (e.g., automated payment for gasoline at a gas station)

Referring again to FIG. 10E, operation 1030 may include operation 1044 depicting providing potential transaction data related to one or more of the extrinsic client configured to use the extrinsic client payment channel and the vendor configured to use the vendor payment channel, to an intermediary device configured to communicate with an extrinsic client device associated with the extrinsic client using a proprietary communication channel. For example, FIG. 5, e.g., FIG. 5E, shows transaction data related to one or more of the extrinsic client and the vendor and configured to be used by the intermediary device providing to the intermediary device configured to communicate with an extrinsic client device associated with the extrinsic client through access to a proprietary communication channel module 544 providing potential transaction data related to one or more of the extrinsic client (e.g., a food truck patron) configured to use the extrinsic client payment channel (e.g., an extrinsic client payment modality of “fingerprint authentication for bank account information”) and the vendor (e.g., the food truck) configured to use the vendor payment channel (e.g., a vendor payment modality of credit card verification with signature and a vendor payment option of credit card alpha), to an intermediary device (e.g., a device of a user that is also waiting in line for the food truck) configured to communicate with an extrinsic client device associated with the extrinsic client using a proprietary communication channel (e.g., a form of communication that is shared by proprietary devices, e.g., through a specialized cable, connector, wireless frequency, encryption, or the like).

FIGS. 11A-11B depict various implementations of operation 708 depicting providing resource data to one or more of the extrinsic client and the vendor, said resource data related to the identified one or more resources, according to embodiments. Referring now to FIG. 11, e.g., FIG. 11A, operation 708 may include operation 1102 depicting providing contact data of an intermediary device configured to assist in facilitation of the potential transaction to one or more of the extrinsic client and the vendor, said contact data regarding contact with the intermediary device. For example, FIG. 6, e.g., FIG. 6A, shows contact instruction for contact of intermediary device configured to assist in facilitation of the potential transaction providing to one or more of the extrinsic client and the vendor module 602 providing contact data (e.g., data that allows a device, person, or other entity to establish or attempt to establish communication with) of an intermediary device (e.g., a wearable smart watch) configured to assist in facilitation of the potential transaction (e.g., purchasing a dozen glazed donut pastries from a donut shop) to one or more of the extrinsic client (e.g., the shopper) and the vendor (e.g., the donut shop). said contact data regarding contact with the intermediary device (e.g., the wearable smart watch).

Referring again to FIG. 11A, operation 1102 may include operation 1104 depicting providing an internet protocol address and an authentication phrase of an intermediary device configured to assist in facilitation of the potential transaction to one or more of the extrinsic client and the vendor. For example, FIG. 6, e.g., FIG. 6A, shows internet protocol address and authentication phrase for contact of intermediary device configured to assist in facilitation of the potential transaction providing to one or more of the extrinsic client and the vendor module 604 providing an internet protocol address and an authentication phrase (e.g., a code that, when given to the intermediary device, will verify that the device that give the authentication phrase is authentic and is the device intended to be involved in the transaction) of an intermediary device (e.g., an augmented reality pair of glasses, e.g., Google Glass, from another player in a game that is not the extrinsic client) configured to assist in facilitation of the potential transaction (e.g., paying for in-game items in an augmented reality game that the extrinsic client is playing in, and wishes to purchase an in-game item) to one or more of the extrinsic client (e.g., the user purchasing the in-game item in an augmented reality setting) and the vendor (e.g., a seller of in-game augmented reality items).

Referring again to FIG. 11A, operation 708 may include operation 1106 depicting providing credential data of an intermediary device configured to assist in facilitation of the potential transaction to one or more of the extrinsic client and the vendor, said credential data configured to allow the intermediary device to recognize the one or more of the extrinsic client and the vendor. For example, FIG. 6, e.g., FIG. 6A, shows credential data for a gain of access to an intermediary device configured to assist in facilitation of the potential transaction providing to one or more of the extrinsic client and the vendor module 606 providing credential data (e.g., data that is given to the vendor and/or the extrinsic client, so that when they contact the intermediary device, the intermediary device can confirm that the vendor and the extrinsic client each are authentic and not a scammer device performing a third party attack on their transaction, and to ensure that the proper parties are involved) of an intermediary device (e.g., an augmented reality pair of glasses) configured to assist in facilitation of the potential transaction (e.g., buying food products at a conveyor-belt style sushi restaurant) to one or more of the extrinsic client (e.g., the dining party) and the vendor (e.g., the sushi restaurant), said credential data configured to allow the intermediary device (e.g., the augmented reality pair of glasses) to recognize the one or more of the extrinsic client (e.g., the dining party) and the vendor (e.g., the sushi restaurant).

Referring again to FIG. 11A, operation 708 may include operation 1108 depicting providing identification data of an intermediary device configured to assist in facilitation of the potential transaction to one or more of the extrinsic client and the vendor. For example, FIG. 6, e.g., FIG. 6A, shows identifying data for verifying an identity of an intermediary device configured to assist in facilitation of the potential transaction providing to one or more of the extrinsic client and the vendor module 608 providing identification data (e.g., data that identifies, either specifically (e.g., a unique identifier) or generally (e.g., this device is an Apple-branded tablet device) of an intermediary device (e.g., an Apple-branded tablet device, e.g., an iPad) configured to assist in facilitation of the potential transaction (e.g., paying for a hamburger and french fries at a fast food restaurant) to one or more of the extrinsic client and the vendor (e.g., the identification data is provided so that the extrinsic client and/or vendor can contact the intermediary device to carry out the transaction of paying for the food).

Referring again to FIG. 11A, operation 708 may include operation 1110 depicting acquiring identification data from an intermediary device configured to assist in facilitation of the potential transaction. For example, FIG. 6, e.g., FIG. 6A, shows intermediary device configured to assist in facilitation of the potential transaction identification data acquiring module 610 acquiring identification data (e.g., a device identifier, a MAC address, an IP address, or similar) from an intermediary device (e.g., a smartphone device of a user that is also in line for a book or game or movie release) configured to assist in facilitation of the potential transaction (e.g., the purchasing on the release date of a popular book or game or movie).

Referring again to FIG. 11A, operation 708 may include operation 1112 depicting anonymizing the acquired identification data into anonymous intermediary data. For example, FIG. 6, e.g., FIG. 6A, shows acquired intermediary device identification data anonymizing into anonymous intermediary device data module 612 anonymizing (e.g., changing, altering, deleting, or obscuring one or more uniquely identifying portions of) the acquired identification data (e.g., the device identifier, a MAC address, an IP address, or similar) into anonymous intermediary data (e.g., data that is still tied to the intermediary device, but which cannot be used to uniquely identify the intermediary device without addition resources (e.g., a lookup table or a decryption key, or similar).

Referring again to FIG. 11A, operation 708 may include operation 1114 depicting providing the anonymous intermediary data to one or more of the extrinsic client and the vendor. For example, FIG. 6, e.g., FIG. 6A, shows anonymous intermediary device data providing to one or more of the extrinsic client and the vendor module 614

Referring again to FIG. 11A, operation 1112 may include operation 1116 depicting altering the acquired identification data to remove data that would uniquely identify the intermediary device to one or more of the extrinsic client and the vendor. For example, FIG. 6, e.g., FIG. 6A, shows acquired intermediary device identification data altering through removal of data configured to uniquely identify the intermediary device to one or more of the extrinsic client and the vendor module 616 altering (e.g., changing one or more bits of the data string) the acquired identification data (e.g., data that identifies the intermediary device) to remove data (e.g., in an embodiment, deleting, but not necessarily deleting, can also include changing or obscuring) that would uniquely identify the intermediary device (e.g., a tablet device carried by a person at a baseball game) to one or more of the extrinsic client (e.g., a fan at a baseball game that is purchasing a scorecard) and the vendor (e.g., a concession salesman).

Referring again to FIG. 11A, operation 1112 may include operation 1118 depicting replacing the acquired identification data with a protected value that is configured to facilitate contact between the intermediary device and one or more of the extrinsic client and the vendor and that is configured to obscure an identity of the intermediary device to one or more of the extrinsic client and the vendor. For example, FIG. 6, e.g., FIG. 6A, shows acquired intermediary device identification data replacement with protected value configured to obscure data configured to uniquely identify the intermediary device to one or more of the extrinsic client and the vendor module 618 replacing the acquired identification data (e.g., a unique device ID that was assigned by a marketplace that controls application purchases for the device, e.g., an application marketplace that functions similarly to Apple's application store) with a protected value (e.g., a value that allows the intermediary device to be contacted through the external coordination device, but anyone outside the external coordination device cannot derive the device's identifier) that is configured to facilitate contact between the intermediary device (e.g., a laptop device of a user that is also on the train) and one or more of the extrinsic client (e.g., a passenger trying to purchase a train ticket after the passenger is on the train) and the vendor and that is configured to obscure an identity of the intermediary device (e.g., the value allows the intermediary device to be contacted through the external coordination device, but anyone outside the external coordination device cannot derive the device's identifier) to one or more of the extrinsic client (e.g., a passenger trying to purchase a train ticket after the passenger is on the train) and the vendor (e.g., the train ticket taker and the device used to scan and issue tickets).

Referring now to FIG. 11B, operation 708 may include operation 1120 depicting providing an offer to facilitate the potential transaction on behalf of an intermediary device configured to assist in facilitation of the potential transaction to one or more of the extrinsic client and the vendor. For example, FIG. 6, e.g., FIG. 6B, shows offer to facilitate the potential transaction on behalf of an intermediary device configured to assist in facilitation of the potential transaction providing to one or more of the extrinsic client and the vendor module 620 providing (e.g., presenting, allowing to access, transmitting to, and the like) an offer to facilitate the potential transaction (e.g., purchasing movie theater popcorn after being seated at the movie theater) on behalf of an intermediary device (e.g., a different device of a user seated three rows away in the same movie theater) configured to assist in facilitation (e.g., to allow the extrinsic client to appear to use at least a portion of the extrinsic client payment channel of the potential transaction (e.g., purchasing movie theater popcorn after being seated at the movie theater) to one or more of the extrinsic client (e.g., the moviegoer) and the vendor.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
acquiring a request for assistance in a facilitation of a potential transaction between an extrinsic client configured to use an extrinsic client payment channel and a vendor configured to use a vendor payment channel that is at least partially different than the extrinsic client payment channel;
identifying one or more resources configured to assist in the facilitation of the potential transaction between the extrinsic client and the vendor, said identifying at least partially based on a characteristic of the one or more resources;
providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction; and
providing resource data to one or more of the extrinsic client and the vendor, said resource data related to the identified one or more resources.

2. (canceled)

3. (canceled)

4. (canceled)

5. (canceled)

6. The computationally-implemented method of claim 1, wherein said acquiring a request for assistance in a facilitation of a potential transaction between an extrinsic client configured to use an extrinsic client payment channel and a vendor configured to use a vendor payment channel that is at least partially different than the extrinsic client payment channel comprises:
receiving, from the extrinsic client, a request for assistance in a facilitation of the potential transaction between the extrinsic client configured to use the extrinsic client payment channel and the vendor configured to use the vendor payment channel that is at least partially different than the extrinsic client payment channel.

7. (canceled)

8. (canceled)

9. (canceled)

10. The computationally-implemented method of claim 6, wherein said receiving, from the extrinsic client, a request for assistance in a facilitation of the potential transaction between the extrinsic client configured to use the extrinsic client payment channel and the vendor configured to use the vendor payment channel that is at least partially different than the extrinsic client payment channel comprises:
receiving, from the extrinsic client device associated with the extrinsic client, a request for assistance in facilitation of the potential transaction between the extrinsic client and the vendor configured to use the vendor payment channel that is at least partially different from the extrinsic client payment channel.

11. The computationally-implemented method of claim 10, wherein said receiving, from the extrinsic client device associated with the extrinsic client, a request for assistance in facilitation of the potential transaction between the extrinsic client and the vendor configured to use the vendor payment channel that is at least partially different from the extrinsic client payment channel comprises:
receiving, from an extrinsic client device associated with the extrinsic client and having a particular characteristic, a request for assistance in facilitation of the potential transaction between the extrinsic client having the particular characteristic and the vendor configured to use the vendor payment channel that is at least partially different from the extrinsic client payment channel.

12. The computationally-implemented method of claim 11, wherein said receiving, from an extrinsic client device associated with the extrinsic client and having a particular characteristic, a request for assistance in facilitation of the potential transaction between the extrinsic client having the particular characteristic and the vendor configured to use the vendor payment channel that is at least partially different from the extrinsic client payment channel comprises:
receiving, from an extrinsic client device associated with the extrinsic client and configured to execute a particular application, a request for assistance in facilitation of the potential transaction between the extrinsic client having the particular characteristic and the vendor configured to use the vendor payment channel that is at least partially different from the extrinsic client payment channel.

13. The computationally-implemented method of claim 12, wherein said receiving, from an extrinsic client device associated with the extrinsic client and configured to execute a particular application, a request for assistance in facilitation of the potential transaction between the extrinsic client having the particular characteristic and the vendor configured to use the vendor payment channel that is at least partially different from the extrinsic client payment channel comprises:
receiving, from an extrinsic client device associated with the extrinsic client and configured to execute a particular proprietary application, a request for assistance in facilitation of the potential transaction between the extrinsic client having the particular characteristic and the vendor configured to use the vendor payment channel that is at least partially different from the extrinsic client payment channel.

14. The computationally-implemented method of claim 13, wherein said receiving, from an extrinsic client device associated with the extrinsic client and configured to execute a particular proprietary application, a request for assistance in facilitation of the potential transaction between the extrinsic client having the particular characteristic and the vendor configured to use the vendor payment channel that is at least partially different from the extrinsic client payment channel comprises:
receiving, from an extrinsic client device associated with the extrinsic client and configured to execute a particular proprietary application configured to locate other devices having the particular proprietary application, a request for assistance in facilitation of the potential transaction between the extrinsic client having the particular characteristic and the vendor configured to use the vendor payment channel that is at least partially different from the extrinsic client payment channel.

15. The computationally-implemented method of claim 1, wherein said acquiring a request for assistance in a facilitation of a potential transaction between an extrinsic client configured to use an extrinsic client payment channel and a vendor configured to use a vendor payment channel that is at least partially different than the extrinsic client payment channel comprises:
receiving, from an uninvolved entity having a relationship with one or more of the extrinsic client and the vendor, the indication of the potential transaction between the extrinsic client configured to use an extrinsic client payment channel and the vendor configured to use the vendor payment channel that is at least partially different than the extrinsic client payment channel.

16. (canceled)

17. (canceled)

18. The computationally-implemented method of claim 1, wherein said acquiring a request for assistance in a facilitation of a potential transaction between an extrinsic client configured to use an extrinsic client payment channel and a vendor configured to use a vendor payment channel that is at least partially different than the extrinsic client payment channel comprises:
receiving, from an intermediary device having a relationship with one or more of the extrinsic client and the vendor, the request for assistance in the facilitation of the potential transaction between the extrinsic client and the vendor; and
receiving, from the intermediary device having the relationship with one or more of the extrinsic client and the vendor, an offer to assist in the facilitation the potential transaction between the extrinsic client and the vendor.

19. (canceled)

20. (canceled)

21. The computationally-implemented method of claim 1, wherein said acquiring a request for assistance in a facilitation of a potential transaction between an extrinsic client configured to use an extrinsic client payment channel and a vendor configured to use a vendor payment channel that is at least partially different than the extrinsic client payment channel comprises:
receiving, using a proprietary communication channel, a request for assistance in facilitation of the potential transaction between the extrinsic client configured to use the extrinsic client payment channel and the vendor configured to use the vendor payment channel that is at least partially different from the extrinsic client payment channel.

22. The computationally-implemented method of claim 21, wherein said receiving, using a proprietary communication channel, a request for assistance in facilitation of the potential transaction between the extrinsic client configured to use the extrinsic client payment channel and the vendor configured to use the vendor payment channel that is at least partially different from the extrinsic client payment channel comprises:
receiving, using a communication channel available only to one or more devices of a particular type, a request for assistance in facilitation of the potential transaction between the extrinsic client configured to use the extrinsic client payment channel and the vendor configured to use the vendor payment channel that is at least partially different from the extrinsic client payment channel.

23. (canceled)

24. The computationally-implemented method of claim 1, wherein said identifying one or more resources configured to assist in the facilitation of the potential transaction between the extrinsic client and the vendor, said identifying at least partially based on a characteristic of the one or more resources comprises:
identifying an intermediary device configured to assist in the facilitation of the potential transaction between the extrinsic client and the vendor, said identifying at least partly based on a characteristic of the intermediary device.

25. (canceled)

26. (canceled)

27. (canceled)

28. The computationally-implemented method of claim 24, wherein said identifying an intermediary device configured to assist in the facilitation of the potential transaction between the extrinsic client and the vendor, said identifying at least partly based on a characteristic of the intermediary device comprises:
identifying an intermediary device configured to assist in the facilitation of the potential transaction between the extrinsic client and the vendor, said identifying at least partly based on a feature present on the intermediary device.

29. The computationally-implemented method of claim 28, wherein said identifying an intermediary device configured to assist in the facilitation of the potential transaction between the extrinsic client and the vendor, said identifying at least partly based on a feature present on the intermediary device comprises:
identifying an intermediary device configured to assist in the facilitation of the potential transaction between the extrinsic client and the vendor, said identifying at least partly based on a capacity to use one or more of the vendor payment channel and the extrinsic client payment channel.

30. (canceled)

31. The computationally-implemented method of claim 24, wherein said identifying an intermediary device configured to assist in the facilitation of the potential transaction between the extrinsic client and the vendor, said identifying at least partly based on a characteristic of the intermediary device comprises:
identifying an intermediary device configured to assist in the facilitation of the potential transaction between the extrinsic client and the vendor, said identifying at least partly based on an intermediary device type.

32. The computationally-implemented method of claim 31, wherein said identifying an intermediary device configured to assist in the facilitation of the potential transaction between the extrinsic client and the vendor, said identifying at least partly based on an intermediary device type comprises:
identifying an intermediary device configured to assist in the facilitation of the potential transaction between the extrinsic client and the vendor, said identifying at least partly based on a manufacturer of the intermediary device.

33. The computationally-implemented method of claim 24, wherein said identifying an intermediary device configured to assist in the facilitation of the potential transaction between the extrinsic client and the vendor, said identifying at least partly based on a characteristic of the intermediary device comprises:
identifying an intermediary device configured to assist in the facilitation of the potential transaction between the extrinsic client and the vendor, said identifying at least partly based on one or more applications present on a memory of the intermediary device.

34. The computationally-implemented method of claim 1, wherein said identifying one or more resources configured to assist in the facilitation of the potential transaction between the extrinsic client and the vendor, said identifying at least partially based on a characteristic of the one or more resources comprises:
obtaining a list of one or more resources configured to assist in the facilitation of the potential transaction between the extrinsic client and the vendor; and
identifying a particular resource from the one or more resources at least partly based on a characteristic of the particular resource.

35. The computationally-implemented method of claim 34, wherein said obtaining a list of one or more resources configured to assist in the facilitation of the potential transaction between the extrinsic client and the vendor comprises:
obtaining a list of one or more resources that have a characteristic in common, said one or more resources configured to assist in the facilitation of the potential transaction between the extrinsic client and the vendor.

36. (canceled)

37. (canceled)

38. (canceled)

39. The computationally-implemented method of claim 34, wherein said obtaining a list of one or more resources configured to assist in the facilitation of the potential transaction between the extrinsic client and the vendor comprises:
monitoring one or more known devices to obtain a list of one or more devices configured to assist in the facilitation of the potential transaction between the extrinsic client and the vendor.

40. The computationally-implemented method of claim 39, wherein said monitoring one or more known devices to obtain a list of one or more devices configured to assist in the facilitation of the potential transaction between the extrinsic client and the vendor comprises:
polling one or more devices that have previously accessed a marketplace, to obtain a list of one or more devices configured to assist in the facilitation of the potential transaction between the extrinsic client and the vendor.

41. (canceled)

42. (canceled)

43. (canceled)

44. (canceled)

45. (canceled)

46. The computationally-implemented method of claim 1, wherein said providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction comprises:
providing transaction data related to the vendor, to the identified one or more resources, said potential transaction data configured to be used by the one or more resources to facilitate the potential transaction.

47. (canceled)

48. The computationally-implemented method of claim 1, wherein said providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction comprises:
providing data regarding a property of the potential transaction between the extrinsic client and the vendor, to the identified one or more resources, said data regarding the property of the potential transaction configured to be used by the one or more resources to determine whether to agree to assist in facilitation of the potential transaction.

49. (canceled)

50. The computationally-implemented method of claim 1, wherein said providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction comprises:
providing one or more instructions for assistance in facilitation of the potential transaction between the extrinsic client and the vendor to the identified one or more resources, said instructions for assistance in facilitation of the potential transaction configured to be used by the one or more resources.

51. The computationally-implemented method of claim 50, wherein said providing one or more instructions for assistance in facilitation of the potential transaction between the extrinsic client and the vendor to the identified one or more resources, said instructions for assistance in facilitation of the potential transaction configured to be used by the one or more resources comprises:
providing one or more instructions for adapting the extrinsic client payment channel for use with the vendor payment channel to assist in facilitation of the potential transaction between the extrinsic client and the vendor, to the identified one or more resources.

52. (canceled)

53. The computationally-implemented method of claim 50, wherein said providing one or more instructions for assistance in facilitation of the potential transaction between the extrinsic client and the vendor to the identified one or more resources, said instructions for assistance in facilitation of the potential transaction configured to be used by the one or more resources comprises:
providing one or more instructions for a collection of payment from the extrinsic client through use of the extrinsic client payment channel;
providing one or more instructions for a dispersal of payment to the vendor through use of the vendor payment channel; and
providing one or more instructions for use of data gathered in the collection of payment from the extrinsic client through use of the extrinsic client payment channel, in the dispersal of payment to the vendor through use of the vendor payment channel.

54. The computationally-implemented method of claim 1, wherein said providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction comprises:
providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction.

55. The computationally-implemented method of claim 54, wherein said providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction comprises:
providing potential transaction data that includes an authorization for the intermediary device to access an account associated with the extrinsic client, to an intermediary device having a particular property, said potential transaction data configured to be used by the intermediary device to facilitate the potential transaction.

56. (canceled)

57. The computationally-implemented method of claim 54, wherein said providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction comprises:
providing potential transaction data that includes an instruction for adapting the extrinsic client payment channel for use with the vendor payment channel, to an intermediary device that is configured to execute a same particular proprietary application as the extrinsic client device carried by the extrinsic client, said potential transaction data configured to be used by the intermediary device to facilitate the potential transaction.

58. (canceled)

59. The computationally-implemented method of claim 54, wherein said providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction comprises:
providing potential transaction data related to one or more of the extrinsic client configured to use the extrinsic client payment channel and the vendor configured to use the vendor payment channel, to an intermediary device that is anonymous to one or more of the extrinsic client and the vendor, said potential transaction data configured to be used by the intermediary device to facilitate the potential transaction.

60. The computationally-implemented method of claim 54, wherein said providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction comprises:
providing potential transaction data related to one or more of the extrinsic client configured to use the extrinsic client payment channel and the vendor configured to use the vendor payment channel, to an intermediary device that has an identity that is hidden from one or more of the extrinsic client and the vendor, said potential transaction data configured to be used by the intermediary device to facilitate the potential transaction.

61. The computationally-implemented method of claim 54, wherein said providing potential transaction data related to one or more of the extrinsic client configured to use the extrinsic client payment channel and the vendor configured to use the vendor payment channel, to an intermediary device, said potential transaction data configured to be used by the intermediary to facilitate the potential transaction comprises:
providing potential transaction data related to one or more of the extrinsic client configured to use the extrinsic client payment channel and the vendor configured to use the vendor payment channel, to an intermediary device configured to communicate with an extrinsic client device associated with the extrinsic client using a proprietary communication channel.

62. The computationally-implemented method of claim 1, wherein said providing resource data to one or more of the extrinsic client and the vendor, said resource data related to the identified one or more resources comprises:
providing contact data of an intermediary device configured to assist in facilitation of the potential transaction to one or more of the extrinsic client and the vendor, said contact data regarding contact with the intermediary device.

63. (canceled)

64. (canceled)

65. The computationally-implemented method of claim 1, wherein said providing resource data to one or more of the extrinsic client and the vendor, said resource data related to the identified one or more resources comprises:
providing identification data of an intermediary device configured to assist in facilitation of the potential transaction to one or more of the extrinsic client and the vendor.

66. The computationally-implemented method of claim 1, wherein said providing resource data to one or more of the extrinsic client and the vendor, said resource data related to the identified one or more resources comprises:
acquiring identification data from an intermediary device configured to assist in facilitation of the potential transaction;
anonymizing the acquired identification data into anonymous intermediary data; and
providing the anonymous intermediary data to one or more of the extrinsic client and the vendor.

67. The computationally-implemented method of claim 66, wherein said anonymizing the acquired identification data into anonymous intermediary data comprises:
altering the acquired identification data to remove data that would uniquely identify the intermediary device to one or more of the extrinsic client and the vendor.

68. The computationally-implemented method of claim 66, wherein said anonymizing the acquired identification data into anonymous intermediary data comprises:
replacing the acquired identification data with a protected value that is configured to facilitate contact between the intermediary device and one or more of the extrinsic client and the vendor and that is configured to obscure an identity of the intermediary device to one or more of the extrinsic client and the vendor.

69. (canceled)

70. (canceled)

71. A computationally-implemented system, comprising circuitry for acquiring a request for assistance in a facilitation of a potential transaction between an extrinsic client configured to use an extrinsic client payment channel and a vendor configured to use a vendor payment channel that is at least partially different than the extrinsic client payment channel;
circuitry for identifying one or more resources configured to assist in the facilitation of the potential transaction between the extrinsic client and the vendor, said identifying at least partially based on a characteristic of the one or more resources;
circuitry for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction; and
circuitry for providing resource data to one or more of the extrinsic client and the vendor, said resource data related to the identified one or more resources.

72-140. (canceled)

141. A device defined by a computational language comprising:
one or more interchained physical machines ordered for acquiring a request for assistance in a facilitation of a potential transaction between an extrinsic client configured to use an extrinsic client payment channel and a vendor configured to use a vendor payment channel that is at least partially different than the extrinsic client payment channel;
one or more interchained physical machines ordered for identifying one or more resources configured to assist in the facilitation of the potential transaction between the extrinsic client and the vendor, said identifying at least partially based on a characteristic of the one or more resources;
one or more interchained physical machines ordered for providing potential transaction data related to one or more of the extrinsic client configured to use the extrinsic payment channel and the vendor configured to use the vendor payment channel, to the identified one or more resources, said potential transaction data configured to be used by the one or more resources to facilitate the potential transaction; and
one or more interchained physical machines ordered for providing resource data to one or more of the extrinsic client and the vendor, said resource data related to the identified one or more resources.
